(19) United States
(12) Patent Application Publication
(10) Pub. No.: US 2026/0304084 A1
(43) Pub. Date: Oct. 1, 2026

(54) METHOD AND APPARATUS FOR MODIFYING SESSION, METHOD AND APPARATUS FOR FORWARDING INFORMATION, AND COMMUNICATION DEVICE

(71) Applicant: VIVO MOBILE COMMUNICATION CO., LTD., Guangdong (CN)

(72) Inventors: Yizhong ZHANG, Guangdong (CN); Yanchao KANG, Guangdong (CN)

(73) Assignee: VIVO MOBILE COMMUNICATION CO., LTD., Guangdong (CN)

(21) Appl. No.: 19/467,507

(22) Filed: Feb. 2, 2026

Related U.S. Application Data
(63) Continuation of application No. PCT/CN2024/108022, filed on Jul. 29, 2024.

(30) Foreign Application Priority Data
Aug. 2, 2023 (CN) 202310967666.3

(51) Int. Cl. H04W 4/50; H04L 41/16; H04L 41/5009; H04L 41/5067; H04W 48/18

(52) U.S. Cl. CPC H04W 4/50; H04L 41/16; H04L 41/5009; H04L 41/5067; H04W 48/18

(57) ABSTRACT

A method and apparatus for modifying a session, a method and apparatus for forwarding information, and a communication device. The method for modifying a session in embodiments of the present application includes: sending, by a terminal, a first request message to a first network function, where the first request message is used for requesting modification of a first session, the first session is used for bearing data of a first service, the first service includes at least one of an artificial intelligence AI service or a computing service, and the first network function is used for managing the first service; and receiving, by the terminal, a first response message from the first network function, where the first response message indicates a modification result of the first session.

### CROSS-REFERENCE TO RELATED APPLICATIONS

This application is a continuation of International Application No. PCT/CN2024/108022 filed on Jul. 29, 2024, which claims priority to Chinese Patent Application No. 202310967666.3 filed on Aug. 2, 2023, which are incorporated herein by reference in their entireties.

### TECHNICAL FIELD

The present application belongs to the technical field of communication, and particularly relates to a method and apparatus for modifying a session, a method and apparatus for forwarding information, and a communication device.

### BACKGROUND

Artificial intelligence (AI) is currently widely applied across various fields. Integrating AI into a communication network to significantly improve technical indicators such as throughput, time delay, and user capacity constitutes a key optimization direction for future communication networks.

In the related art, a network data analytics function (NWDAF) is introduced to perform some intelligent analysis. Specifically, the NWDAF has certain AI intelligent analysis or computing capabilities. The NWDAF collects some data, calculates or analyzes some results by using a built-in algorithm and analysis capability, and provides the results to a core network element of a 5th-generation (5G) or beyond 5th-generation (B5G) communication system, to perform some operation optimization or statistical analysis. However, currently, a core network only uses an NWDAF network element to perform operation optimization related to AI or computation, and does not support the provision for user equipment (UE) or a third party with AI as a service for use.

It can be learned from this that how to perform introduction or modification to support an AI or computing service in a session becomes a problem to be urgently resolved.

### SUMMARY

Embodiments of the present application provide a method and apparatus for modifying a session, a method and apparatus for forwarding information, and a communication device.

A first aspect provides a method for modifying a session. The method includes:
sending, by a terminal, a first request message to a first network function, where the first request message is used for requesting modification of a first session, the first session is used for bearing data of a first service, the first service includes at least one of an artificial intelligence AI service or a computing service, and the first network function is used for managing the first service; and
receiving, by the terminal, a first response message from the first network function, where the first response message indicates a modification result of the first session.

A second aspect provides a method for modifying a session. The method includes:
receiving, by a first network function, a first request message from a terminal, where the first request message is used for requesting modification of a first session, the first session is used for bearing data of a first service, the first service includes at least one of an artificial intelligence AI service or a computing service, and the first network function is used for managing the first service; and
sending, by the first network function, a first response message to the terminal, where the first response message indicates a modification result of the first session.

A third aspect provides a method for forwarding information. The method includes:
receiving, by a communication management function, fourth information from a terminal; and
sending, by the communication management function, a first request message to a first network function according to the fourth information, where the first network function is used for managing a first service, and
the fourth information includes at least one of the following:
the first request message, where the first request message is used for requesting modification of a first session, the first session is used for bearing service data of the first service, and the first service includes at least one of an artificial intelligence AI service or a computing service; or
a second request message, where the second request message is used for requesting modification of a communication bearer related to the first session, and the second request message includes the first request message.

A fourth aspect provides an apparatus for modifying a session. The apparatus includes:
a first sending module configured to send a first request message to a first network function, where the first request message is used for requesting modification of a first session, the first session is used for bearing data of a first service, the first service includes at least one of an artificial intelligence AI service or a computing service, and the first network function is used for managing the first service; and
a first reception module configured to receive a first response message from the first network function, where the first response message indicates a modification result of the first session.

A fifth aspect provides an apparatus for modifying a session. The apparatus includes:
a second reception module configured to receive a first request message from a terminal, where the first request message is used for requesting modification of a first session, the first session is used for bearing data of a first service, the first service includes at least one of an artificial intelligence AI service or a computing service, the apparatus for modifying a session has a first network function, and the first network function is used for managing the first service; and
a second sending module configured to send a first response message to the terminal, where the first response message indicates a modification result of the first session.

A sixth aspect provides an apparatus for forwarding information. The apparatus includes:
a third reception module configured to receive fourth information from a terminal; and
a third sending module configured to send a first request message to a first network function according to the fourth information, where the first network function is used for managing a first service, and
the fourth information includes at least one of the following:
the first request message, where the first request message is used for requesting modification of a first session, the first session is used for bearing service data of the first service, and the first service includes at least one of an artificial intelligence AI service or a computing service; or
a second request message, where the second request message is used for requesting modification of a communication bearer related to the first session, and the second request message includes the first request message.

A seventh aspect provides a terminal. The terminal includes a processor and a memory. The memory stores a program or instructions runnable on the processor. The program or the instructions, when executed by the processor, implement steps of the method according to the first aspect.

An eighth aspect provides a terminal. The terminal includes a processor and a communication interface. The communication interface is configured to send a first request message to a first network function. The first request message is used for requesting modification of a first session. The first session is used for bearing data of a first service. The first service includes at least one of an artificial intelligence AI service or a computing service. The first network function is used for managing the first service. The communication interface is further configured to receive a first response message from the first network function. The first response message indicates a modification result of the first session.

A ninth aspect provides a network side device. The network side device includes a processor and a memory.

In a case that the network side device has a first network function, the memory stores a program or instructions runnable on the processor. The program or the instructions, when executed by the processor, implement steps of the method according to the second aspect.

In a case that the network side device has a communication management function, the memory stores a program or instructions runnable on the processor. The program or the instructions, when executed by the processor, implement steps of the method according to the third aspect.

A tenth aspect provides a network side device. The network side device includes a processor and a communication interface.

In a case that the network side device has a first network function, the communication interface is configured to receive a first request message from a terminal. The first request message is used for requesting modification of a first session. The first session is used for bearing data of a first service. The first service includes at least one of an artificial intelligence AI service or a computing service. The first network function is used for managing the first service. The communication interface is further configured to send a first response message to the terminal. The first response message indicates a modification result of the first session.

In a case that the network side device has a communication management function, the communication interface is configured to receive fourth information from the terminal. The communication interface is further configured to send a first request message to a first network function according to the fourth information. The first network function is used for managing a first service.

The fourth information includes at least one of the following:
the first request message, where the first request message is used for requesting modification of a first session, the first session is used for bearing service data of the first service, and the first service includes at least one of an artificial intelligence AI service or a computing service; or
a second request message, where the second request message is used for requesting modification of a communication bearer related to the first session, and the second request message includes the first request message.

An eleventh aspect provides a readable storage medium. The readable storage medium stores a program or instructions. The program or the instructions, when executed by a processor, implement steps of the method according to the first aspect, the second aspect, or the third aspect.

A twelfth aspect provides a wireless communication system. The wireless communication system includes a terminal, a network side device having a first network function, and a network side device having a communication management function. The terminal may be configured to perform steps of the method according to the first aspect. The network side device having a first network function may be configured to perform steps of the method according to the second aspect. The network side device having a communication management function may be configured to perform steps of the method according to the first aspect.

A thirteenth aspect provides a chip. The chip includes a processor and a communication interface. The communication interface is coupled to the processor. The processor is configured to run a program or instructions, to implement the method according to the first aspect, the second aspect, or the third aspect.

A fourteenth aspect provides a computer program/program product. The computer program/program product is stored in a storage medium. The computer program/program product is executed by at least one processor, to implement steps of the method according to the first aspect, the second aspect, or the third aspect.

### BRIEF DESCRIPTION OF THE DRAWINGS

FIG. 1 is a schematic structural diagram of a wireless communication system to which embodiments of the present application is applicable;

FIG. 2 is a first flowchart of a method for modifying a session according to an embodiment of the present application;

FIG. 3a is a first schematic diagram of an information architecture of a first request message according to an embodiment of the present application;

FIG. 3b is a second schematic diagram of an information architecture of a first request message according to an embodiment of the present application;

FIG. 3c is a first schematic interactive diagram of a session modification process according to an embodiment of the present application;

FIG. 4a is a third schematic diagram of an information architecture of a first request message according to an embodiment of the present application;

FIG. 4b is a fourth schematic diagram of an information architecture of a first request message according to an embodiment of the present application;

FIG. 4c is a second schematic interactive diagram of a session modification process according to an embodiment of the present application;

FIG. 5a is a fifth schematic diagram of an information architecture of a first request message according to an embodiment of the present application;

FIG. 5b is a third schematic interactive diagram of a session modification process according to an embodiment of the present application;

FIG. 6a is a sixth schematic diagram of an information architecture of a first request message according to an embodiment of the present application;

FIG. 6b is a fourth schematic interactive diagram of a session modification process according to an embodiment of the present application;

FIG. 7 is a second flowchart of a method for modifying a session according to an embodiment of the present application;

FIG. 8 is a flowchart of a method for forwarding information according to an embodiment of the present application;

FIG. 9 is a first schematic structural diagram of an apparatus for modifying a session according to an embodiment of the present application;

FIG. 10 is a second schematic structural diagram of an apparatus for modifying a session according to an embodiment of the present application;

FIG. 11 is a schematic structural diagram of an apparatus for forwarding information according to an embodiment of the present application;

FIG. 12 is a schematic structural diagram of a communication device according to an embodiment of the present application;

FIG. 13 is a schematic structural diagram of a terminal according to an embodiment of the present application; and

FIG. 14 is a schematic structural diagram of a network side device according to an embodiment of the present application.

### DETAILED DESCRIPTION

The technical solutions in embodiments of the present application are clearly described in the following with reference to the accompanying drawings in the embodiments of the present application. Apparently, the described embodiments are some embodiments rather than all embodiments of the present application.

The terms “first”, “second”, and so forth in the present application are used for distinguishing between similar objects, instead of describing a particular order or sequential order. It should be understood that the terms used in this way may be transposed where appropriate, such that the embodiments of the present application may be implemented in a sequence other than those illustrated or described herein. Moreover, objects defined by “first” and “second” are generally of the same class and do not limit a quantity of objects. For example, one or more first objects may be arranged. Furthermore, “or” in the present application indicates at least one of connected objects. For example, “A or B” covers three solutions, that is, solution 1: including A and excluding B; solution 2: including B and excluding A; and solution 3: including both A and B. The character “/” generally indicates that the associated objects are in an “or” relationship.

The term “indication” in the present application may be a direct indication (or explicit indication) or an indirect indication (or implicit indication). The direct indication may be understood as that a sender explicitly informs a receiver of specific information, operations to be performed or request results, and the like in the indication sent by the sender. The indirect indication may be understood as that a receiver determines corresponding information according to the indication sent by a sender, or performs judgment and determines operations to be performed or request results, and the like according to judgment results.

It should be noted that, the technology described in the embodiments of the present application is not limited to a long term evolution (LTE)/LTE-advanced (LTE-A) system, and may further be applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. Terms “system” and “network” in the embodiments of the present application are usually interchangeably used. The described technology may be applied to both the system and the radio technology mentioned above, or may be applied to another system and radio technology. A new radio (NR) system is described below as an example. The term NR is used in most of the following description. Nevertheless, these technologies may alternatively be applied to a system other than the NR system, such as a 6th Generation (6G) communication system.

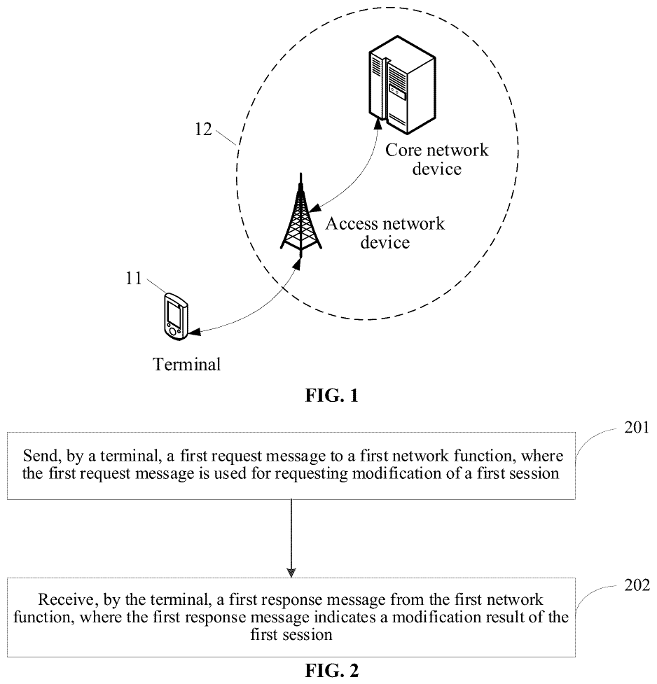

FIG. 1 shows a block diagram of a wireless communication system to which the embodiments of the present application are applicable. The wireless communication system includes a terminal 11 and a network side device 12. The terminal 11 may be a terminal device such as a mobile phone, a tablet personal computer, a laptop computer, a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, a flight vehicle, vehicle user equipment (VUE), ship user equipment, a pedestrian user equipment (PUE), a smart home (a home device having a wireless communication function, such as a refrigerator, a television, a washing machine, or furniture), a game console, a personal computer (PC), a teller machine, or a self-service machine. The wearable device includes: a smart watch, a smart bracelet, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The vehicle user equipment may alternatively be referred to as a vehicle user terminal, a vehicle user controller, a vehicle user module, a vehicle user component, a vehicle user chip, a vehicle user unit, or the like. It should be noted that a specific type of the terminal 11 is not limited in the embodiments of the present application. The network side device 12 may include an access network device or a core network device. The access network device may alternatively be referred to as a radio access network (RAN), a radio access network function, or a radio access network unit. The access network device may include a base station, a wireless local area network (WLAN) access point (AP), a wireless fidelity (WiFi) node, or the like. The base station may be referred to as a node B (NB), an evolved mode B (eNB), the next generation node B (gNB), a new radio node B (NR Node B), an access point, a relay base station (RBS), a serving base station (SBS), a base transceiver station (BTS), a radio base station, a radio transceiver, a basic service set (BSS), an extended service set (ESS), a home node B (HNB), a home evolved node B, a transmission reception point (TRP) or some other suitable terms in the field as long as the same technical effect is achieved. The base station is not limited to a specific technical word. It is to be noted that in the embodiments of the present application, introduction is made only taking the base station in the NR system as an example, and the specific type of the base station is not limited.

The core network device may include, but is not limited to, at least one of the following: a core network node, a core network function, a location management function (LMF), a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), unified data repository (UDR), a home subscriber server (HSS) centralized network configuration (CNC), a network repository function (NRF), a network exposure function (NEF), local NEF (L-NEF), a binding support function (BSF), an application function (AF), and the like. It should be noted that the core network device in the NR system is used only as an example for description in the embodiments of the present application, and a specific type of the core network device is not limited. It should be noted that the core network device in the NR system is used only as an example for description in the embodiments of the present application, and a specific type of the core network device is not limited.

In the related art, an NWDAF is introduced to perform some intelligent analysis. Specifically, the NWDAF has some AI intelligent analysis capabilities. The NWDAF collects some data, analyzes some results by using a built-in algorithm and analysis capability, and provides the results to a core network element of a 5th-generation (5G) communication system, to perform some operation optimization or statistical analysis. However, the NWDAF cannot provide the AI service for the UE.

For ease of understanding a method for modifying a session provided in the embodiments of the present application, the following nouns or terms in the embodiments of the present application are first explained and described.

1) First service, which may alternatively be referred to as AI service or computing service, provides an AI resource or a computing resource as a service to a terminal. For ease of description, in the embodiments of the present application, an example in which the first service is an AI service is used for description, and this is not specifically limited herein.

(2) First session, which may alternatively be referred to as AI session, is a process of communication between UE and an AI resource node. After an AI session is established, a data transmission channel between UE and an AI resource node is established. Thus, in a case that the UE needs to use an AI service (for example, AI data transmission), an AI session needs to be established first. In other words, the AI session is an AI resource established between the UE and the AI resource node. Moreover, the AI session may alternatively be sometimes referred to as AI service connection, or AI connection.

3) First request message is a message used for requesting modification of a first session. For example, in a case that the first session is an AI session, the first request message may be an AI session modification request message, an AI service bearer modification request message, or an AI bearer modification request message.

4) Second request message is a message used for requesting modification of a communication bearer related to a first session. For example, in a case that the first session is an AI session, and the AI session is transmitted by using a data radio bearer (DRB) of a protocol data unit (PDU) session, that is, user plane data (through a UPF) of the AI session is transmitted to an AI resource node by using a transmission channel of the PDU session for processing, a communication bearer related to the first session includes the PDU session. In this case, the second request message may be a PDU session modification request message.

It should be noted that the foregoing first request message may be carried in the second request message. For example, signaling related to the AI is borne in an AI container, and the AI container is a dedicated information element (IE) container in a PDU session modification message; or the first request message may be used for requesting modification of the first session and the communication bearer related to the first session, or the second request message may be carried in the first request message. This is not specifically limited herein.

Moreover, in some implementations, the AI session has a communication requirement (such as quality of service (QoS)), but in an AI session modification process, whether to modify an AI bearer or a communication bearer is not limited. That is, in an AI session modification process, only an AI resource, only a communication resource, or both an AI resource and a communication resource may be modified.

5) Logical functions of function network elements in the embodiments of the present application are shown in Table 1:

TABLE 1

| Names of network | | |
|---|---|---|
| elements | Description of functions | Example |
| Network access | An endpoint of an access network (AN) signaling | NAS interface |
| server (NAS) | interface (N2), and an endpoint of NAS (N1) | function, AMF |
| interface function | signaling (mobility management (MM) message); | |
| | and | |
| | responsible for encryption and integrity protection | |
| | of an NAS message, and responsible for functions | |
| | such as registration, access, mobility management, | |
| | authentication, and messaging. | |
| Communication | An endpoint of an SM message of an NAS | Communication |
| management | message; | management function, |
| function | establishing, modifying, or releasing a session; | SMF |
| | allocating and managing a UE IP; | |
| | selecting and controlling a UPF; | |
| | collecting charging data and supporting a charging | |
| | interface; | |
| | determining a session and service continuity (SSC) | |
| | mode of a session; and | |
| | a downlink data indication. | |
| Communication | Used for an anchor point for intra-radio access | Communication |
| resource node | technology (RAT)/inter-RAT mobility (when | resource node, UPF |
| | applicable); a session point for interconnection of | |
| | an external PDU to a data network; packet routing | |
| | and forwarding | |
| | packet inspection; and policy rule enforcement, for | |
| | example, gating, redirection, traffic steering, for a | |
| | user plane part. | |
| Policy charging | Application and service data traffic detection, and | Policy charging |
| function | policy (UE policy, session policy, and the like) | function, PCF |
| | generation and provision | |
| First network | Used for performing service management and | AI service |
| function | service identity parsing, and specifically, | management function, |
| | converting an external AI service request into an | external service |
| | internal AI resource management function and/or a | management function, |
| | communication resource management process; and | service management |
| | considering a type of an AI service and a QoS | function, and |
| | requirement of the AI service to determine a | computing power |
| | required AI resource. | service management |
| | | function |
| Second network | Used for model management, and specifically, | AI model management |
| function | determining a suitable model according to an | function, model |
| | external model request | management function |
| Third network | Used for service resource management, | AI resource |
| function | specifically, allocation updating and releasing of an | management function, |
| | AI/computing power resource according to a | resource management |
| | requirement; and state updating and maintenance of | function, and |
| | an AI/computing power resource node (AI RF) | computing power |
| | | resource management |
| | | function |
| First resource node | Used for performing service processing and service | AI resource node, |
| | policy rule implementation, and specifically, | resource node, |
| | performing calculation processing (a user plane | computing power |
| | performance process) of an AI service according to | resource node, and |
| | a command of an AI resource management | service resource node |
| | function; and updating an AI resource state for an | |
| | AI resource management function | |
| Fourth network | Used for performing data management, including | Data plane |
| function | determining a data source according to a data | management function |
| | request | |
| Data source | Used for generating, storing, and forwarding data | Data source |
| network element | | |
| First | Used for performing external service processing, | Application server |
| communication | specifically, processing and feeding back data | (AS) and application |
| device | forwarded by a resource node | function (AF) |

6) First network side device may include a forwarding node between a terminal and an AI service management function network element. For example, a first network side device includes at least one of an NAS interface function, a communication management function, a policy charging function, or a user plane function.

It should be noted that in the embodiments of the present application, a logical function of a network element is used as a subject for description, but it is not limited whether at least two function network elements are combined. For example, whether an AI service management function and an AI resource node are a same function node or different function nodes is not limited. For another example, whether an AI service management function and a communication management function are a same function node or different function nodes is not limited. In a case that network elements of two different logical functions are co-located, an interaction process between the two logical functions is an internal process of a function node, and corresponding steps may be not performed. For ease of description, in the embodiments of the present application, an example in which network elements having logical functions are separately set is usually used for description, and this is not specifically limited herein.

7) AI service data is data borne on an AI session. In some implementations, the AI session may be transmitted by using a communication bearer. That is, user plane data of the AI session is transmitted (for example, through a UPF) to an AI resource node for processing by using a transmission channel of an existing communication bearer.

For ease of description, in the embodiments of the present application, an example in which a communication bearer is a protocol data unit (PDU) session is used for description. For example, an AI session may be transmitted by using a data radio bearer (DRB) of a PDU session.

The PDU session is a process of communication between one piece of UE and a data network (DN). After the PDU session is established, a data transmission channel between the UE and the DN is established. Thus, in the related art, in a case that the UE needs to perform data transmission with an application, a PDU session needs to be established first. In other words, the PDU session is a communication resource established between the UE and the application in a 5G network.

In the related art, the PDU session establishment process is briefly described as follows:

The UE initiates a PDU session establishment request to the network (sent to the SMF through the AMF), where a PDU session ID is allocated to the UE and reported to the network; and the SMF allocates a corresponding transmission resource (communication resource) to the PDU session of the UE, and the process includes selecting a user plane node UPF, and triggering establishment of a user plane. After the user plane is established, the UE may perform data transmission by using the established user plane corresponding to the PDU session.

In the related art, the PDU session modification process is briefly described as follows:

the UE initiates a PDU session modification request to the network (sent to the SMF through the AMF), where the UE carries information such as the PDU session ID, a requested quality of service rule (QoS rule), and requested quality of service flow description (QoS Flow description); and the SMF performs authorization and modifies a corresponding PDU session based on the request of the UE.

8) AI session ID is used for identifying an AI session. In some implementations, the AI session ID is allocated by the UE and is sent to the network when the AI session is established. In some implementations, the AI session ID and the PDU session ID have an association, for example, a one-to-one mapping relationship or a many-to-one mapping relationship. After determining the mapping relationship, the UE sends the mapping relationship to the network when the AI session is established. In a case that a plurality of AI session IDs are mapped to a same PDU session ID, the plurality of AI sessions may use a same PDU session for transmission. That is, the plurality of AI session IDs corresponds to the same PDU session ID.

9) First layer, which may alternatively be referred to as an AI management layer, an AI layer, and the like, indicates a layer on which AI-related signaling is located, for example, a layer on which a first request message is encapsulated.

In the embodiment of the present application, by establishing an AI session between an AI resource node and UE, end-to-end support can be provided for an AI-related service and application. That is, AI is provided as a service for the UE or a third party for use. After the AI session is established, a network side device or a third party node may modify the AI session. The AI session may be understood as a bearer of an end-to-end dedicated computing communication resource established between the UE and a network. Generally, in order to support an AI service, the established AI bearer needs to allocate at least one of a communication resource or an AI resource to the UE.

A method for modifying a session, a method for forwarding information, an apparatus for modifying a session, an apparatus for forwarding information, and a communication device according to the embodiments of the present application will be described in detail below with some embodiments and their application scenarios in conjunction with the accompanying drawings.

With reference to FIG. 2, a method for modifying a session according to an embodiment of the present application is shown. An execution subject for the method is a terminal. As shown in FIG. 2, the method for modifying a session includes the following steps:

Step 201: The terminal sends a first request message to a first network function. The first request message is used for requesting modification of a first session. The first session is used for bearing data of a first service. The first service includes at least one of an artificial intelligence AI service or a computing service. The first network function is used for managing the first service.

Step 202: The terminal receives a first response message from the first network function. The first response message indicates a modification result of the first session.

For ease of description, in the embodiment of the present application, an example in which the first service is an AI service is usually used for description. In this case, the first session may be an AI session. The first network function may be an AI service management function. The first request message may be AI signaling or AI-related signaling.

Optionally, the first session satisfies at least one of the following:
the first session is a bearer between the terminal and a first resource node (for example, an AI resource node);
the first session has a first identity, for example, an AI session identity, uniquely identifying the first session;
the first session has at least one of a dedicated data network name (DNN) or single network slice selection assistance information (S-NSSAI); or
the first session has a quality of service QoS guarantee between the terminal and a first resource node, where
the first resource node includes a network function for processing the first service.

In some implementations, through the first request message, the terminal may request the AI service management function to modify at least one of the following of the AI session:
a transmission mode of the data of the first service;
a service resource of the first service;
a data source of the first service;
a model of the first service; or
a bearer of the first session.

In some implementations, the AI resource node may require the terminal to send data to assist requirements on a network side, for example, performing AI training. The requirements may be locally determined by the AI resource node. In some other implementations, the AI resource node may require, due to a service requirement, the terminal to send AI service data in a particular mode. In this case, through the first request message, the terminal may request modification of a transmission mode in which the terminal sends the AI service data, such as a frequency or a period of transmitting the AI service data.

In some implementations, the terminal may request, through the first request message, adjustment of AI resource information of the terminal. For example, subscription information of UE changes.

In some implementations, the terminal may request, through the first request message, modification of a data source of the terminal in an AI service.

In some implementations, the terminal may request, through the first request message, modification of a model used by the terminal in an AI service.

Optionally, the first response message includes at least one of the following of the modified first session:
a session ID, QoS information, service policy information (that is, AI policy information), service resource configuration information (that is, AI resource configuration information), data source information, or model information.

The service resource configuration information is used for instructing the first resource node to process and forward the service data of the first service. In an implementation, the service resource configuration information includes at least one of the following:
data source information of the first service, for example, data source information of an AI service;
service resource information of the first service, for example, AI resource information;
detection information of the first service, for example, AI service detection information;
a processing rule of the first service, for example, an AI service processing rule; or
AS address information of the first service, for example, AS address information of an AI service.

The AI service detection information is used for detecting or identifying an AI service traffic reaching the AI resource node.

In some implementations, the AI service detection information includes at least one of the following: source interface information (used for indicating information about an AI service traffic source sender), a terminal IP address (used for indicating IP address information of the terminal), network slice information, transmission tunnel information (such as communication resource tunnel information and AI resource tunnel information), a packet filter group (used for identifying each AI service traffic data packet), an application identity (used for indicating information about an application that generates the AI service traffic), QoS flow information (such as QoS flow identity information), session indication information of an Ethernet type, a fully qualified domain name (FQDN) filter used for DNS query, or protocol information (such as protocol description information, a protocol name, and a protocol identity).

The foregoing AI service processing rule is used for determining a processing rule of the AI service traffic reaching the AI resource node.

In some implementations, the processing operation includes at least one of the following: forward, duplicate, drop, buffer, or compute.

In some other implementations, the AI service processing rule includes at least one of the following: network slicing information, target interface information (used for indicating information about an AI service traffic source target), rule information (used for indicating which processing operation is performed on an AI service traffic data packet), or identity information (the identity information may identify a processing operation or rule information).

In the implementation, the terminal may be informed of, through the first response message, at least one of the session ID, the QoS information, the AI policy information, the AI resource configuration information, the data source information, or the model information of the modified first session, such that the terminal transmits the AI service data based on the modified AI session.

In some implementations, the terminal directly sends the first request message to the first network function. For example, the first request message is transmitted by using a communication bearer between the terminal and the first network function.

In some implementations, the terminal may send the first request message to the first network function through forwarding of the first network side device. For example, the first request message sent by the terminal is forwarded to the first network function through at least one of a communication management function or an NAS interface function.

It should be noted that the first request message is included in an AI container. The AI container is used for bearing AI-related signaling. Whether the terminal directly sends the first request message to the first network function or the terminal may send the first request message to the first network function through forwarding of the first network side device is related to an encapsulation architecture of the first request message.

Specifically, the first request message is encapsulated in a first layer. The first layer satisfies any one of the following:
the first layer is an upper layer of a non-access stratum session management (NAS-SM) layer;
the first layer is an upper layer of a non-access stratum mobility management (NAS-MM) layer, and is parallel to an NAS-SM layer;
the first layer is located between an NAS-MM layer and an NAS-SM layer;
the first layer is an upper layer of a UE route selection policy (URSP) layer;
the first layer is an NAS-SM layer; or
the first layer is an upper layer of a protocol data unit PDU layer.

For ease of description, in the embodiment of the present application, the first layer encapsulating the first request message is referred to as an AI layer. The first request message may have different transmission paths according to different AI layers.

Optionally, the terminal sends a first request message to the first network function as follows:
the terminal sends the first request message to the first network function through a first network side device, where the first network side device has at least one of the following functions:
an NAS interface function;
a communication management function;
a policy charging function; or
a user plane function.

Moreover, in some implementations, the first request message may be located in the PDU session modification message. For example, an AI container encapsulating the first request message is a dedicated information element (IE) container in the PDU session modification message. The PDU session modification message may be a request message that is sent by the terminal and is used for requesting modification of a PDU session related to the AI session.

In some other implementations, the first request message and the PDU session modification message are not in an inclusion relationship. For example, an AI container encapsulating the first request message is outside the PDU session modification message.

For ease of understanding, the following specific architectures are used as examples for analysis.

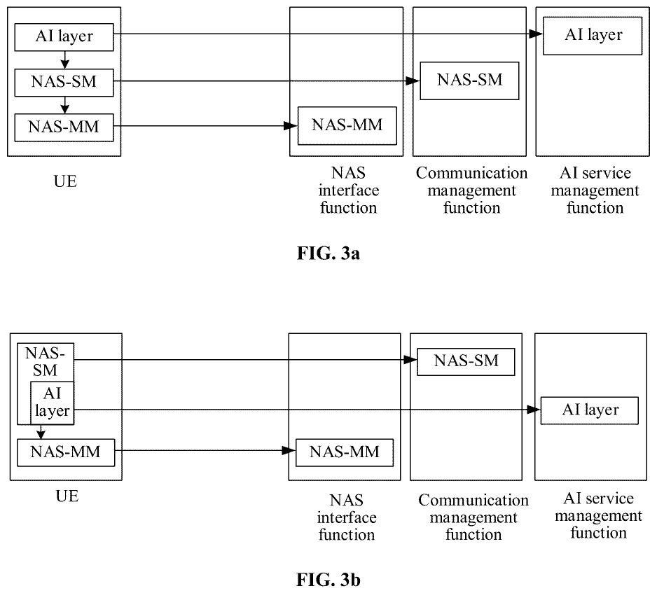

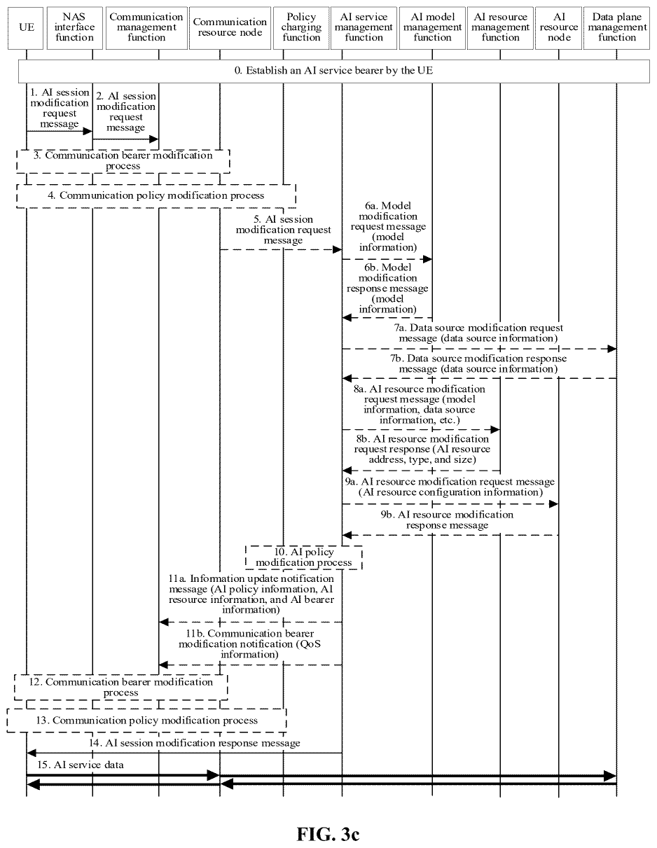

In a first implementation, as shown in FIG. 3a, the AI layer is located at an upper layer of the NAS-SM layer, or, as shown in FIG. 3b, the AI layer is merely an enhancement of the NAS-SM layer.

In this case, in a case that the first request message sent by the terminal may be located in the PDU session modification message, the first request message may be located in the SM message (for example, the PDU session modification message); or in a case that the first request message sent by the terminal and the PDU session modification message are not in an inclusion relationship, the first request message and the SM message (for example, the PDU session modification message) may be sent in parallel.

Then, the NAS interface function forwards the first request message to the communication management function such as the SMF, and then the communication management function sends the first request message to the AI service management function.

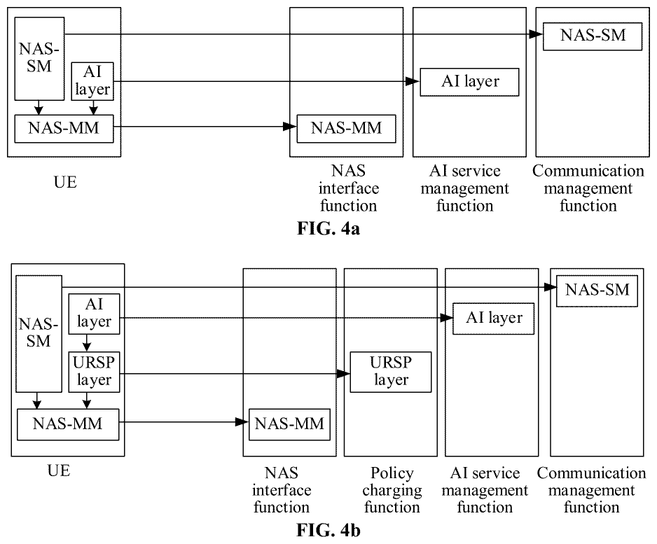

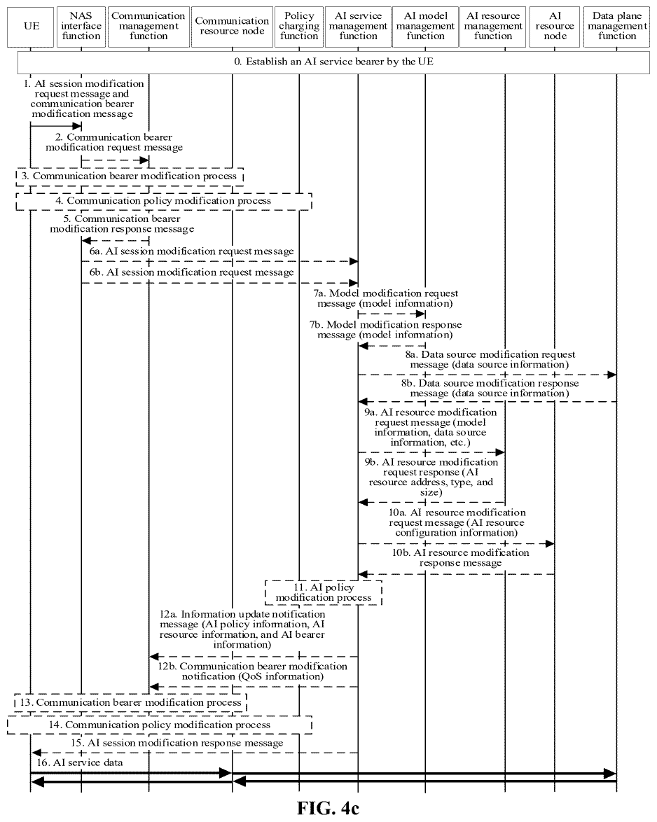

In a second implementation, as shown in FIG. 4a, the AI layer is located at the upper layer of the NAS-MM layer, and is parallel to the NAS-SM layer. In this case, the first request message sent by the terminal is similar to SM signaling. That is, the first request message is generally considered to be included in an MM message, and is forwarded through an NAS interface function (for example, an AMF) to the AI service management function, to trigger AI-related functions.

Or, as shown in FIG. 4b, the AI layer is located at the upper layer of the URSP layer. In this case, the first request message sent by the terminal is carried on the URSP layer. The first request message is directly routed by the policy charging function PCF to the AI service management function. However, the URSP layer and the SM layer are two independent layers, that is, an SM container and a UE policy container arrive at the AMF at the same time.

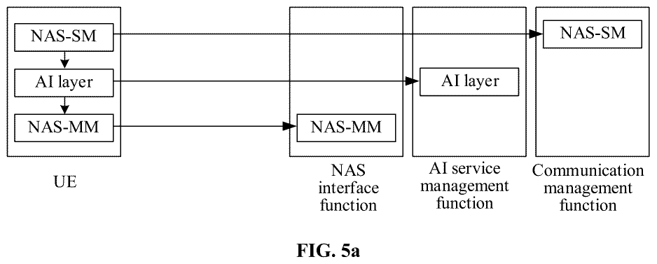

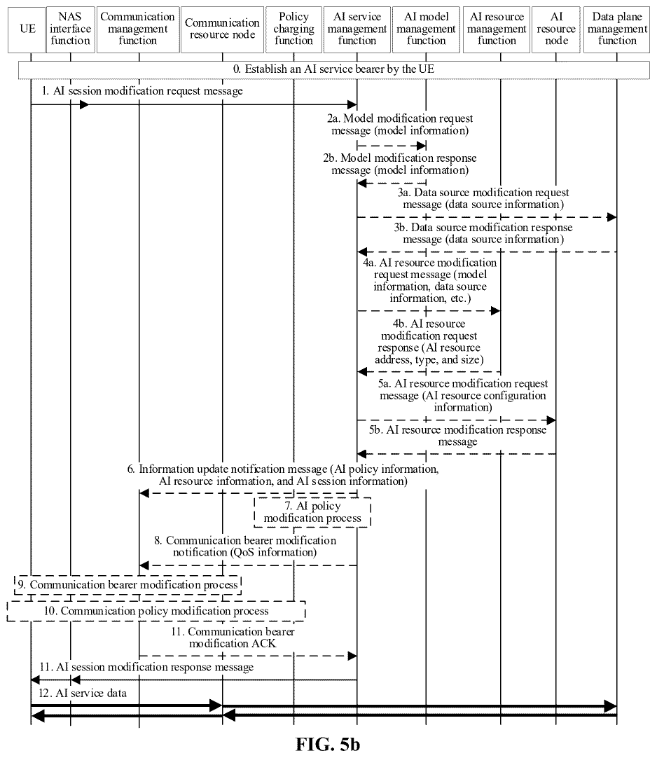

In a third implementation, as shown in FIG. 5a, the AI layer is located between the NAS-MM layer and the NAS-SM layer. Under such an architecture, SM signaling in the related art is used as an upper layer of the AI layer. In this case, as shown in FIG. 5b, the first request message is directly routed by the NAS interface function (for example, the AMF) to the AI service management function.

Optionally, in a case that modification of the first session triggered by the first request message influences a communication bearer related to the first session, the first request message may further trigger modification of the communication bearer. For example, the AI service management function triggers the communication management function to modify the communication bearer.

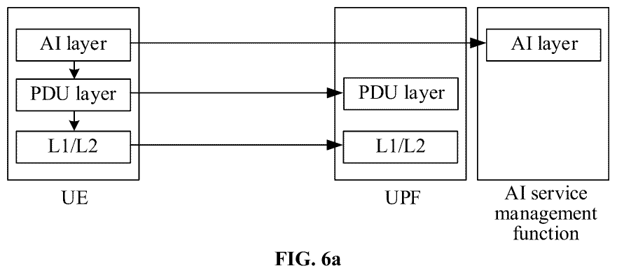

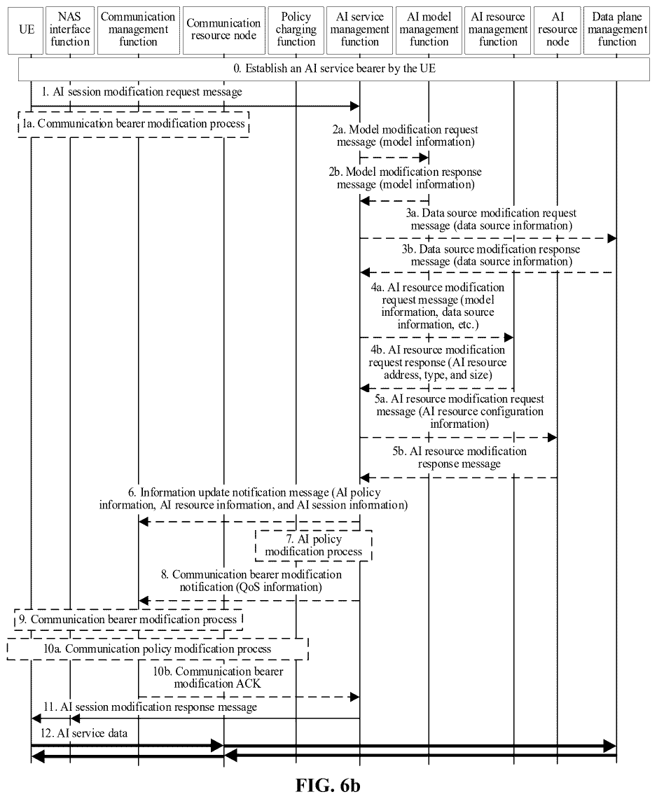

In a fourth implementation, as shown in FIG. 6a, the AI layer is located at the upper layer of the PDU layer. Under such an architecture, the first request message is transmitted through a user plane. That is, the terminal first establishes the PDU session, then uses the user plane of the PDU session to send control signaling to the AI service management function to modify the AI session, and then may use the PDU session to transmit AI-related data. The AI signaling and data may be sent by using different QoS flows in the PDU session. That is, a QoS flow of the AI signaling is a UE-AI service management function, and a QoS flow of the AI data is a UE-UPF-AI resource node.

As an optional implementation, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

In some implementations, the requirement description information of the first service may be referred to as AI service requirement description information. The AI service requirement description information may be used for describing information, related to the AI service, of which the first request message requests modification. For example, the requirement description information of the first service includes at least one of the following:
an identity of the first service, such as an inference service (specifically, an environment reconstruction service, a facial recognition service, . . . ) or a training service;
a quality of experience (QoE) requirement of the first service;
quality of service QoS information of the first service, such as an AI service processing delay, AI service processing accuracy, an AI service computational load, and a data processing scale;
model information of the first service, such as a model identity, model precision, and a model downloading address; or
second indication information, where the second indication information indicates whether interaction with a target network function needs to be performed.

Optionally, the target network function may include at least one of a second network function, a third network function, a fourth network function, or a first resource node. The second network function is a model management function or an AI model management function. The third network function is an AI resource management function, a resource management function, or a computing power resource management function. The fourth network function is a data plane management function.

In the implementation, based on the AI service requirement description information, the AI service management function may determine the AI session needing modification and information about the AI session needing modification, such as modifying at least one of a data source, a model, an AI bearer, an AI resource, an AI policy, or other information of the AI session.

In some implementations, the session type indication may indicate a type of a session that requests modification. For example, the session that requests modification is an AI session or a PDU session.

It should be noted that the session type indication may indicate modification of both the AI session and the PDU session. For example, in a case that the second request message carries the first request message, the modification of both the AI session and the PDU session is indicated through one session type indication.

It should be noted that it is considered that the AI session has a communication requirement (such as QoS), but in an AI session modification process, whether to modify an AI bearer and/or a communication bearer is not limited. That is, in an AI session modification process, only an AI resource, only a communication resource, or both an AI resource and a communication resource may be modified.

In some implementations, the first information may be PDU session information that is used for indicating that a network allocates communication resources corresponding to the AI session. The communication resources include: a PDU session ID, a PDU session type, QoS information (including a QoS flow identity, a QoS rule, QoS flow description information, and the like), a DNN, and S-NSSAI.

In some implementations, the second information may be AI session information that is used for describing an AI session. The AI session includes: an AI session ID, an AI session type, a DNN related to the AI session, a slice related to the AI session, and QoS information (including a QoS flow identity, a QoS rule, QoS flow description information, and the like) related to the AI session.

In some implementations, the first indication information may be used for indicating that the AI service needs participation of an AS.

In some implementations, the AS address information may be address information of an AS participating in the AI service, for example, including at least one piece of address information such an Internet protocol (IP) address, a port number, a fully qualified domain name (FQDN), or a uniform resource locator (URL) of the AS.

Optionally, the terminal may obtain the AS address information through a domain name system (DNS) query.

As an optional implementation, the method further includes:

The terminal determines, based on information of an application layer, at least one of QoS information of the first session or QoS information related to communication.

In a case that the QoS information of the first session influences the QoS information related to communication, the first request message further includes a second request message, the second request message is used for requesting modification of a communication bearer related to the first session, or the first request message is further used for requesting modification of a communication bearer related to the first session.

In some implementations, bearers between the terminal and the AI resource node may include a bearer between the terminal and the communication node, and a bearer between the communication node and the AI resource node. In this case, a situation that the QoS information of the first session influences the QoS information related to the communication may be understood as: in a case that the QoS information between the terminal and the AI resource node is modified, the QoS information of the bearer between the terminal and the communication node may need modification. For example, assuming that a communication delay requirement between the terminal and the AI resource node is less than 50 ms, and a communication delay between the communication node and the AI resource node is fixed to 20 ms, a communication delay between the terminal and the communication node is required to be less than 30 ms.

In an implementation, AI-related QoS and communication-related QoS are determined by application layer information of the terminal. Accordingly, in a case that QoS of an AI session needing modification influences the communication-related QoS, the terminal may send the second request message when sending the first request message. The second request message may be carried in the first request message, or the first request message carries the QoS information, to request modification of the AI session and a communication bearer related to the AI session, such as the PDU session.

For example, as shown in FIG. 4c, a PDU session modification request message (that is, a communication bearer modification request message or the second request message) based on an application layer QoS requirement may be carried in a step of AI session modification request message (that is, the first request message), to trigger step 3 to step 5 based on the PDU session modification request message. Thus a communication bearer or a communication policy influenced by modifying the QoS of the AI session is implemented.

In the implementation, the AI-related QoS and the communication-related QoS are determined by an application layer of the terminal. Accordingly, in a case that the AI session needing modification influences the communication-related QoS, the terminal, while modifying the AI session, further carries a request message used for modifying the communication bearer and based on the application layer QoS requirement.

In another implementation, a network side may modify the communication bearer based on a modification result of the AI session (for example, considering delay information of the AI session). For example, after considering an end-to-end QoS requirement from the terminal to the AI resource node, the AI service management function updates the communication bearer based on a QoS requirement from the communication resource node (for example, the UPF) to the AI resource node.

For example, as shown in FIG. 4c, in step 1, the terminal may only send the AI session modification request message instead of sending the PDU session modification message, and does not perform step 2 to step 5, but modifies the communication bearer or the communication policy based on the modification result of the AI session in step 13 to step 14.

In the implementation, the network side needs to further modify the communication bearer based on the modification result of the AI session (for example, considering the delay information of the AI session). For example, after considering the end-to-end QoS requirement from the terminal to the AI resource node, the AI service management function further updates a communication bearer between the terminal and the communication resource node based on a QoS requirement from the communication resource node to the AI resource node. With an end-to-end QoS requirement being a delay requirement as an example, the end-to-end QoS requirement from the terminal to the AI resource node is 100 milliseconds, and the QoS requirement from the communication resource node to the AI resource node is 20 milliseconds, and then the network side may determine that a QoS requirement from the terminal to the communication resource node is 80 milliseconds (that is, 100 milliseconds minus 20 milliseconds).

In an optional implementation, the first layer is an upper layer of a PDU layer, and the first request message is transmitted to the first network function through the communication bearer related to the first session.

For example, in an architecture shown in FIG. 6a, the first request message is transmitted through the established PDU session. For example, the terminal first establishes the PDU session, then uses a user plane of the PDU session to send control signaling to the AI service management function, to establish the AI session between the terminal and the AI resource node, and then uses the PDU session to transmit AI-related signaling, to modify the AI session.

In the embodiments of the present application, in a case that the first session between the terminal and the resource node of the first service is established, the terminal may send the first request message to the first network function, to request modification of the first session. The first service may be at least one of the AI service or the computing service. For ease of description, in the embodiments of the present application, an example in which the first service is an AI service is usually used for description. Herein, the first service is not specifically limited to the AI service. Through the embodiments of the present application, a network node related to the AI service and/or the computing service can provide at least one of the AI service or the computing service for the terminal through a session. The terminal can modify an established session for at least one of the AI service or the computing service.

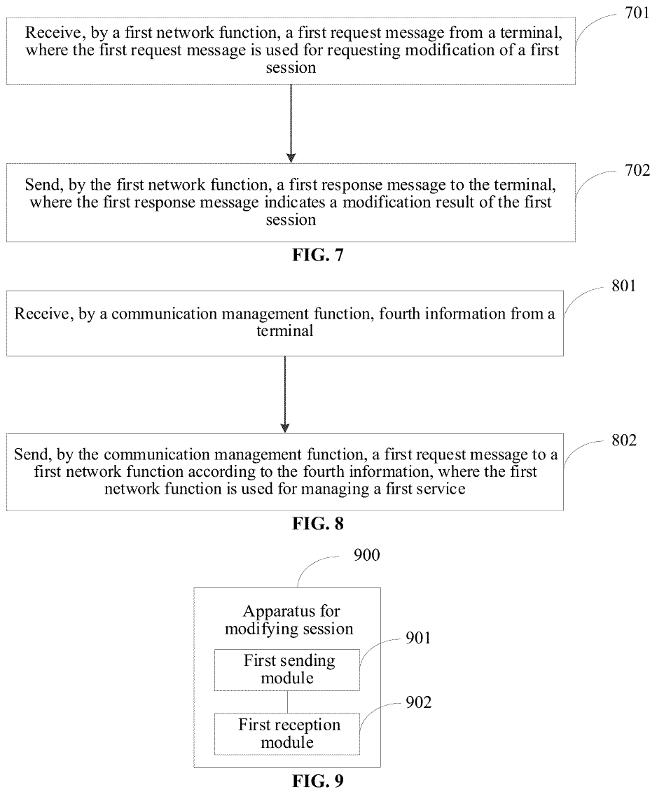

With reference to FIG. 7, an embodiment of the present application provides another method for modifying a session. An execution subject for the method is a first network function, that is, a function used for managing a first service, for example, an AI service management function.

As shown in FIG. 7, the method for modifying a session may include the following steps:

Step 701: A first network function receives a first request message from a terminal. The first request message is used for requesting modification of a first session. The first session is used for bearing data of a first service. The first service includes at least one of an artificial intelligence AI service or a computing service. The first network function is used for managing the first service.

Step 702: The first network function sends a first response message to the terminal. The first response message indicates a modification result of the first session.

In the embodiment of the present application, meanings of the first network function, the first request message, the first session, the first service, and the first response message are the same as those of the first network function, the first request message, the first session, the first service, and the first response message in the method embodiment shown in FIG. 2. Details are not described herein again.

It should be noted that the first request message from the terminal may be understood as that a source address of the first request message is the terminal, and the first request message may be forwarded to the first network function through another node, or the first request message may be directly sent to the first network function through the terminal. This is not specifically limited herein.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node is a network function for processing the first service.

In the embodiment of the present application, a meaning of the first session is the same as that of the first session in the method embodiment shown in FIG. 2. Reference may be made to explanation and description of the first session in the method embodiment shown in FIG. 2 for a meaning related to the first session. Details are not described herein again.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

In the embodiment of the present application, a meaning of the first layer is the same as that of the first layer in the method embodiment shown in FIG. 2. Reference may be made to explanation and description of the first layer in the method embodiment shown in FIG. 2 for a meaning related to the first layer. Details are not described herein again.

Optionally, the first request message is forwarded to the first network function through a first network side device. The first network side device has at least one of the following functions:
an NAS interface function;
a communication management function;
a policy charging function; or
a user plane function.

In the embodiment of the present application, a meaning of the first network side device is the same as that of the first network side device in the method embodiment shown in FIG. 2. Reference may be made to explanation and description of the first network side device in the method embodiment shown in FIG. 2 for a meaning related to the first network side device. Details are not described herein again.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

In the embodiment of the present application, a meaning of the first request message is the same as that of the first request message in the method embodiment shown in FIG. 2. Reference may be made to explanation and description of the first request message in the method embodiment shown in FIG. 2 for a meaning related to the first request message. Details are not described herein again.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

In the embodiment of the present application, a meaning of the requirement description information of the first service is the same as that of the requirement description information of the first service in the method embodiment shown in FIG. 2. Reference may be made to explanation and description of the requirement description information of the first service in the method embodiment shown in FIG. 2 for a meaning related to the requirement description information of the first service. Details are not described herein again.

Optionally, the first response message includes at least one of the following of the modified first session:
a session ID, QoS information, service policy information, service resource configuration information, data source information, or model information.

In the embodiment of the present application, a meaning of the first response message is the same as that of the first response message in the method embodiment shown in FIG. 2. Reference may be made to explanation and description of the first response message in the method embodiment shown in FIG. 2 for a meaning related to the first response message. Details are not described herein again.

As an optional implementation, the method further includes:
the first network function modifies a service policy according to the modified first session.

Assuming that the first session is an AI session, and the service policy is an AI policy, the AI policy may be understood as an AI policy related to the AI session.

It may be understood that in the embodiment of the present application, whether the modification process of the AI policy is initiated by the policy charging function or another network element is not limited.

Optionally, the service policy includes at least one of the following:
data transmission resource information related to the data of the first service, a data forwarding rule related to the data of the first service, a data caching rule related to the data of the first service, network context information related to the data of the first service, a data matching policy of a terminal side for the first session, or a data sending policy of a terminal side for the first session.

The data forwarding rule related to the data of the first service and the data caching rule related to the data of the first service are a data forwarding rule and a data caching rule of first service data applied to a network side. The data matching policy of the terminal side for the first session and the data sending policy of the terminal side for the first session are a data matching policy used for matching service data of the first session and a data sending policy used for sending the service data of the first session, and the data matching policy used for matching the service data of the first session and the data sending policy used for sending the service data of the first session are applied to a terminal side.

In the implementation, the AI service management function may modify at least one of the following of the AI session based on the first request message: a transmission mode of the data of the first service, a service resource of the first service, a data source of the first service, a model of the first service, or a bearer of the first session. At least one of the data plane management function, the AI resource node, the AI model management function, or the AI resource management function responds to a modification request of the AI resource management function. Thereafter, modification of the AI policy may be triggered based on at least one piece of the foregoing modified information. For example, as shown in FIG. 3c, the AI service management function may trigger, based on information obtained in step 6a to step 9b, a process of modifying the AI policy.

As an optional implementation, the method further includes:
the first network function sends third information to the communication management function. The third information includes at least one of the following:
session information of the modified first session; or
a first notification message, where the first notification message is used for indicating that a communication bearer or a communication policy related to the first session is modified.

Assuming that the first session is an AI session, and the communication bearer is a communication bearer of the PDU session, the communication bearer related to the first session may be that an ID of the first session is associated with an ID of the PDU session, or the AI session is transmitted by using a data radio bearer (DRB) of the PDU session.

In an implementation, after completing the modification of the first session, the first network function sends the session information of the modified first session to the communication management function, such that the communication management function correspondingly modifies, according to the modified first session, the communication bearer or the communication policy related to the first session. For example, the communication management function initiates, according to the session information of the modified first session, a PDU session modification process.

Optionally, the session information includes at least one of the following:
service policy information, service resource configuration information, data source information, or model information.

In another implementation, after the modification of the first session is completed, the first network function may determine, according to the modified first session, how to modify the communication bearer or the communication policy related to the first session, to send the first notification message to the communication management function to instruct the communication management function to correspondingly modify the communication bearer or the communication policy related to the first session.

Optionally, the first notification message includes third indication information. The third indication information indicates that the communication management function modifies QoS information of the communication bearer related to the first session. For example, the communication bearer is updated according to an end-to-end QoS requirement from the terminal to the first resource node and a QoS requirement from a communication resource node (for example, an UPF) to the first resource node.

The foregoing two implementations may be combined. For example, the first network function sends the session information of the modified first session and the first notification message to the communication management function, such that the communication management function can determine, according to the session information of the modified first session, whether to modify the communication bearer related to the first session according to notification of the first notification message.

Optionally, the communication policy includes a related policy used on a network side or a terminal side for communication or routing.

In some implementations, a communication policy modification process is an SM policy association modification process.

In some implementations, a communication policy modification process is a UE policy modification process.

In some implementations, the communication policy modification process is used for modifying route information in a network, such as a forwarding action rule (FAR) or a packet detection rule (PDR)

In the implementation, after the first session is modified, the third information may be sent to the communication management function, such that the communication management function triggers the modification of the communication bearer or the communication policy related to the first session.

In an optional implementation, the first network function receives the first request message from the terminal as follows:
the first network function receives the first request message of the terminal that is forwarded by the communication management function. The first layer satisfies any one of the following:
the first layer is an upper layer of a non-access stratum session management NAS-SM layer; or
the first layer is an NAS-SM layer.

For example, as shown in FIG. 3a, in a case that the AI layer is an upper layer of a non-access stratum session management NAS-SM layer, or as shown in FIG. 3b, the AI layer is an NAS-SM layer, as shown in step 1, step 2, and step 5 in FIG. 3c, the AI session modification request message is forwarded to the communication management function through the NAS interface function, and then the communication management function forwards the AI session modification request message to the AI service management function.

In the implementation, in the encapsulation architecture shown in FIG. 3a or FIG. 3b, the first request message sent by the terminal may be forwarded to the AI service management function sequentially through the NAS interface function and the communication management function.

In another optional implementation, the first network function receives the first request message from the terminal as follows:
the first network function receives the first request message of the terminal that is forwarded by the NAS interface function, where the first layer encapsulating the first request message is an upper layer of a non-access stratum mobility management NAS-MM layer and is parallel to an NAS-SM layer, or the first layer is located between an NAS-MM layer and an NAS-SM layer;
or
the first network function receives the first request message of the terminal that is forwarded by the NAS interface function and the policy charging function, where the first layer is an upper layer of a URSP layer.

In an implementation, in a case that as shown in FIG. 4a, the AI layer is an upper layer of a non-access stratum mobility management NAS-MM layer and is parallel to an NAS-SM layer, as shown in step 6a in FIG. 4c, the AI session modification request message sent by the terminal is directly forwarded to the AI service management function through the NAS interface function.

In an implementation, in a case that as shown in FIG. 4b, the AI layer is located between an NAS-MM layer and an NAS-SM layer, as shown in step 6b in FIG. 4c, the AI session modification request message sent by the terminal is forwarded to the AI service management function sequentially through the NAS interface function and the policy charging function.

It should be noted that in a frame shown in FIG. 4a or FIG. 4b, since the NAS-SM and the AI layer are two separate modules, after receiving a corresponding container, the NAS interface function (for example, an AMF) may perform step 2 and step 6 shown in FIG. 4c parallel.

In an implementation, as shown in FIG. 5a, the AI layer is located between an NAS-MM layer and an NAS-SM layer and is parallel to the NAS-SM layer, and then as shown in step 1 in FIG. 5b, since the NAS-SM is an upper layer of the AI layer, after the NAS interface function receives the AI session modification request message of the UE, the AI session modification request message sent by the terminal is directly forwarded to the corresponding AI service management function through the NAS interface function.

In the implementation, in an encapsulation architecture shown in FIG. 4a, the first request message sent by the terminal may be forwarded to the AI service management function through the NAS interface function. Or, in an encapsulation architecture shown in FIG. 4b, the first request message sent by the terminal may be forwarded to the AI service management function sequentially through the NAS interface function and the policy charging function.

In another optional implementation, the first layer is an upper layer of a PDU layer, and the first request message is transmitted to the first network function through the communication bearer related to the first session.

For example, in a case that as shown in FIG. 6a, the AI layer is located at the upper layer of the PDU layer, as shown in step 1 in FIG. 6b, the AI session modification request message is directly sent to the AI service management function through the communication bearer (for example, a PDU session) related to the AI session.

In the implementation, in an encapsulation architecture shown in FIG. 6a, the first request message sent by the terminal may be directly sent to the AI service management function through the communication bearer related to the first session.

In some implementations, the AI service management function may modify, according to the first request message of the terminal, at least one of the following of the first session:
a transmission mode of the data of the first service;
a service resource of the first service;
a data source of the first service;
a model of the first service; or
a bearer of the first session.

The foregoing content of modifying the first session is the same as the content of modifying the first session in the method embodiment shown in FIG. 2. Reference may be made to explanation and description of the content of modifying the first session in the method embodiment shown in FIG. 2 for details. Details are not described herein again.

### Mode One: Determination of Whether to Modify Model Information of a First Service

In an optional implementation, the first network function modifies the first session according to the first request message as follows:
the first network function modifies a model used by the terminal in the first session in a case of determining that the first request message satisfies a first condition.

The first condition includes at least one of the following:
the first request message includes the requirement description information of the first service, and the requirement description information of the first service includes model information;
the requirement description information of the first service includes the QoS information of the first service, and the QoS information of the first service does not match model information used by the terminal;
the second information in the first request message includes the QoS information related to the first session, and the QoS information related to the first session does not match model information used by the terminal; or
the first request message includes the second indication information, the second indication information indicates a need to interact with a second network function, and the second network function is used for model management.

In an implementation, in a case that the first request message includes the requirement description information of the first service, and the requirement description information of the first service includes the model information, the first request message may request modification of the model information of the first service, such as a model identity, model precision, and a model downloading address.

In an implementation, in a case that the requirement description information of the first service includes the QoS information of the first service, and the QoS information of the first service does not match the model information used by the terminal, the first request message may request modification of the QoS information of the first service, and the modified QoS information does not match the model information currently used by the terminal. Consequently, the model information used by the terminal needs to be modified into model information matching the modified QoS information of the first service.

In an implementation, in a case that the second information in the first request message includes the QoS information related to the first session, and the QoS information related to the first session does not match the model information used by the terminal, the first request message may request modification of the QoS information of the first session, and the modified QoS information does not match the model information currently used by the terminal. Consequently, the model information used by the terminal needs to be modified into model information matching the modified QoS information of the first session.

In an implementation, in a case that the first request message includes the second indication information, and the second indication information indicates a need to interact with the second network function, and the second network function is used for model management, the first request message may request interaction with the second network function, and request modification of the model information of the first service according to an interaction result.

In the implementation, in a case that the first request message satisfies the first condition, the first network function may trigger modification of the model information used by the terminal.

### Mode Two: Determination of Whether to Modify Data Source Information of a First Service

In an optional implementation, the first network function modifies the first session according to the first request message as follows:
the first network function modifies a data source of the terminal in the first session in a case of determining that the first request message satisfies a second condition.

The second condition includes at least one of the following:
the first request message carries the data source information;
the first request message includes the second indication information, the second indication information indicates a need to interact with a fourth network function, and the fourth network function is used for performing data management;
the requirement description information of the first service includes the model information, and the model information does not match data source information used by the terminal in the first session;
the requirement description information of the first service includes the QoS information of the first service, and the QoS information of the first service does not match data source information used by the terminal in the first session; or
the second information in the first request message includes the QoS information related to the first session, and the QoS information related to the first session does not match data source information used by the terminal in the first session.

In an implementation, in a case that the first request message carries the data source information, the first request message may request that the data source information of the first service is modified into carried data source information.

In an implementation, in a case that the first request message includes the second indication information, and the second indication information indicates a need to interact with the fourth network function, and the fourth network function is used for performing data management, the first request message may request interaction with the fourth network function, and request modification of the data source information of the first service according to an interaction result.

In an implementation, in a case that the requirement description information of the first service includes the model information, and the model information does not match the data source information used by the terminal in the first session, the first request message may request modification of the model information of the first service, and the modified model information does not match current data source information of the terminal. Consequently, the data source information of the first session used by the terminal needs to be modified into data source information matching the modified model information of the first service.

In an implementation, in a case that the requirement description information of the first service includes the QoS information of the first service, and the QoS information of the first service does not match the data source information used by the terminal in the first session, the first request message may request modification of the QoS information of the first service, and the modified QoS information of the first service does not match current data source information of the terminal. Consequently, the data source information of the first session used by the terminal needs to be modified into data source information matching the modified QoS information of the first service.

In an implementation, in a case that the second information in the first request message includes the QoS information related to the first session, and the QoS information related to the first session does not match the data source information used by the terminal in the first session, the first request message may request modification of the QoS information related to the first session, and the modified QoS information of the first session does not match the data source information currently used by the terminal. Consequently, the data source information used by the terminal needs to be modified into data source information matching the modified QoS information of the first session.

In the implementation, in a case that the first request message satisfies the second condition, the first network function may trigger modification of the data source information used by the terminal.

### Mode Three: Determination of Whether to Modify Service Resource Information of a First Service

In an optional implementation, the first network function modifies the first session according to the first request message as follows:
the first network function modifies a service resource used by the terminal in the first session in a case of determining that the first request message satisfies a third condition.

The third condition includes at least one of the following:
the requirement description information of the first service includes the model information, and the model information does not match service resource information used by the terminal in the first session;
the requirement description information of the first service includes the QoS information of the first service, and the QoS information of the first service does not match service resource information used by the terminal in the first session;
the second information in the first request message includes the QoS information related to the first session, and the QoS information related to the first session does not match service resource information used by the terminal in the first session; or
the first request message includes the second indication information, the second indication information indicates a need to interact with a third network function, and the third network function is used for service resource management.

In an implementation, in a case that the requirement description information of the first service includes the model information, and the model information does not match the service resource information used by the terminal in the first session, the first request message may request modification of the model information of the first service, and the modified model information does not match current service resource information of the terminal. Consequently, the service resource information of the first service used by the terminal needs to be modified into service resource information matching the modified model information of the first service.

In an implementation, in a case that the requirement description information of the first service includes the QoS information of the first service, and the QoS information of the first service does not match the service resource information used by the terminal in the first session, the first request message may request modification of the QoS information of the first service, and the modified QoS information of the first service does not match current service resource information of the first service of the terminal. Consequently, the service resource information of the first service used by the terminal needs to be modified into service resource information matching the modified QoS information of the first service.

In an implementation, in a case that the second information in the first request message includes the QoS information related to the first session, and the QoS information related to the first session does not match the service resource information used by the terminal in the first session, the first request message may request modification of the QoS information related to the first session, and the modified QoS information of the first session does not match the service resource information of the first service currently used by the terminal. Consequently, the service resource information of the first service used by the terminal needs to be modified into service resource information matching the modified QoS information of the first session.

In an implementation, in a case that the first request message includes the second indication information, and the second indication information indicates a need to interact with the third network function, and the third network function is used for service resource management, the first request message may request interaction with the third network function, and request modification of the service resource information of the first service according to an interaction result.

In the implementation, in a case that the first request message satisfies the third condition, the first network function may trigger modification of a service resource used by the terminal.

It should be noted that besides mode one to mode three, the first network function may further trigger modification of the AI bearer, the communication bearer, or the transmission mode of the first service data of the first session. This is not specifically limited herein.

It should be noted that at least two of the first network function, the second network function, the third network function, the fourth network function, and the first resource node may be set in a same network side device, or the first network function, the second network function, the third network function, the fourth network function, and the first resource node may be set in different network side devices respectively.

In a case that the first network function, the second network function, the third network function, the fourth network function, and the first resource node may be set in different network side devices respectively, the first network function needs to interact with the second network function, to modify the model of the first service, or the first network function needs to interact with the third network function, to modify the resource of the first service, or the first network side function needs to interact with the fourth network function, to modify the data source of the first service, or the first network side function needs to interact with the first resource node, to modify the bearer of the first service.

In a case that at least two of the first network function, the second network function, the third network function, the fourth network function, and the first resource node may be co-located in a same network side device, interaction between the at least two co-located logical functions may be omitted. For ease of description, in the embodiment of the present application, for example, the first network function, the second network function, the third network function, the fourth network function, and the first resource node may be set in different network side devices for description. An interaction process between the first network function, the second network function, the third network function, the fourth network function, and the first resource node is not limited herein.

Mode One: Interaction of a First Network Function with a Second Network Function to Modify Model Information of a First Service

In an optional implementation, the method further includes:
the first network function sends a fifth request message to the second network function according to the first request message, where the fifth request message is used for requesting modification of the model of the first service, and the second network function is used for model management; and
the first network function receives a fifth response message from the second network function, where the fifth response message indicates a modification result of the model of the first service.

The fifth request message may be referred to as a model modification request message, and is used for requesting modification of the model of the first service. Moreover, the fifth response message may be a model modification response message.

Optionally, the fifth request message includes at least one of the following:
an identity of the terminal;
a data network name DNN to which the first session belongs;
single network slice selection assistance information S-NSSAI of the first session;
information of a service area to which the first session belongs; or
the requirement description information of the first service.

The second network function such as the AI model management function may select an updated model information according to the fifth request message.

Optionally, the fifth response message indicates a modification result of the model of the first service. The modification result may be that the model modification response message includes the updated model information, or the model modification response message is a model modification request message ACK or a model modification request message negative acknowledgement (NACK).

For example, as shown in step 6a and step 6b in FIG. 3c, the AI service management function sends the model modification request message to the AI model management function. The model modification request message may carry model information needing modification. Then, the AI model management function feeds back the model modification response message to the AI service management function. The model modification response message may carry modified model information.

In an implementation, the updated model information may be that the model information requested by the terminal can be used after being authorized by the AI model management function.

In another implementation, the updated model information may be model information selected by the AI model management function based on the AI service requirement description information, the information of the service area, and the like of the terminal.

Whether the updated model information is the same as the model information determined when the AI session is established is not limited in the embodiment of the present application.

Mode Two: Interaction of a First Network Function with a Fourth Network Function to Modify Data Source Information of a First Service

In an optional implementation, the method further includes:
the first network function sends a sixth request message to the fourth network function according to the first request message, where the sixth request message is used for requesting modification of the data source of the first service, and the fourth network function is used for performing data management; and
the first network function receives a sixth response message from the fourth network function, where the sixth response message indicates a modification result of the data source of the first service.

The sixth request message may be referred to as a data source modification request message, and is used for requesting modification of the data source information of the first service. Moreover, the sixth response message may be a data source modification response message.

The sixth response message indicates a modification result of the data source of the first service. The modification result may be that the data source modification response message includes updated data source information, or the data source modification response message is a data source modification request message ACK or a data source modification request message NACK.

For example, as shown in step 7a and step 7b in FIG. 3c, the AI service management function sends the data source modification request message to the data plane management function. The data source modification request message may carry data source information needing modification. Then, the data plane management function feeds back the data source modification response message to the AI service management function. The data source modification response message may carry modified data source information.

Optionally, the sixth request message includes at least one of the following:
the identity of the terminal;
the data network name DNN to which the first session belongs;
the single network slice selection assistance information S-NSSAI of the first session;
the information of the service area to which the first session belongs; or
the requirement description information of the first service.
   Mode Three: Interaction of a First Network Function with a Third Network Function to Modify Resource Information of a First Service

In an optional implementation, the method further includes:
the first network function sends a seventh request message to the third network function according to the first request message, where the seventh request message is used for requesting modification of a resource of the first service, and the third network function is used for service resource management; and
the first network function receives a seventh response message from the third network function, where the seventh response message indicates a modification result of the resource of the first service.

The seventh request message may be referred to as an AI resource modification request message, and is used for requesting modification of the AI resource information of the first service. Moreover, the seventh response message may be an AI resource modification response message.

Optionally, the seventh response message indicates a modification result of the AI resource information of the first service. The modification result may be that the AI resource modification response message includes updated AI resource information, or the AI resource modification response message is an AI resource modification request message ACK or an AI resource modification request message NACK.

For example, as shown in step 8a and step 8b in FIG. 3c, the AI service management function sends the AI resource modification request message to the AI resource management function. The AI resource modification request message may carry at least one piece of the information such as the model information or the data source information. Then, the AI resource management function feeds back the AI resource modification response message to the AI service management function. The AI resource modification response message may carry the modified AI resource information, such as the AI resource address, the computing power type, and the computing power level.

Optionally, the seventh request message includes at least one of the following:
the identity of the terminal;
the data network name DNN to which the first session belongs;
the single network slice selection assistance information S-NSSAI of the first session;
the information of the service area to which the first session belongs;
the requirement description information of the first service;
the data source information of the first service, for example, a data source identity and data source address information;
a computational load of the first service, for example, a computing power magnitude and a computing power type; or
application server AS address information of the first service, where the address information includes at least one of an IP address, a port number, an FQDN, a URL, or other address information.

Optionally, the AI resource modification response message includes AI resource node information. The AI resource node information includes at least one of the following: address information (the address information includes an IP address, a port number, an FQDN, and a URL) or ID information.

Mode Four: Interaction of a First Network Function with a First Resource Node to Modify a Bearer of a First Session

In an optional implementation, the method further includes:
the first network function sends an eighth request message to the first resource node according to the first request message, where the eighth request message is used for requesting to modification of the bearer of the first session, the eighth request message includes the service resource configuration information, and the first resource node includes the network function for processing the first service; and
the first network function receives an eighth response message from the first resource node, where the eighth response message indicates a modification result of the bearer of the first session.

The eighth request message may be referred to as an AI bearer modification request message, and is used for requesting modification of the bearer of the first session. Moreover, the eighth response message may be an AI bearer modification request response message.

Optionally, the eighth response message indicates a modification result of the bearer of the first session. The modification result may be that the AI bearer modification request response message includes updated AI bearer information, or the AI bearer modification response message is an AI bearer modification request message ACK or an AI bearer modification request message NACK.

The AI bearer modification request message may carry AI resource configuration information. The AI resource configuration information may include at least one of the following: data source information (a data source address and a data source identity), AI service detection information, an AI service processing rule, and the AS address information.

For example, as shown in step 9a and step 9b in FIG. 3c, the AI service management function sends the AI bearer modification request message to the AI resource node. The AI bearer modification request message may carry the AI resource configuration information. Then, the AI resource node feeds back an AI bearer modification response message to the AI service management function. The AI bearer modification response message may carry the modified AI bearer information.

The embodiment of the present application may be combined with the method embodiment shown in FIG. 2, such that the first network function can modify the AI session according to the first request message of the terminal, and feed back a response message requesting modification of the AI session to the terminal. Details are not described herein again.

With reference to FIG. 8, a method for forwarding information according to an embodiment of the present application is shown. An execution subject for the method is a communication management function. As shown in FIG. 8, the method for forwarding information includes the following steps:

Step 801: The communication management function receives fourth information from a terminal.

The fourth information includes at least one of the following:
a first request message, where the first request message is used for requesting modification of a first session, the first session is used for bearing service data of the first service, and the first service includes at least one of an artificial intelligence AI service or a computing service; or
a second request message, where the second request message is used for requesting modification of a communication bearer related to the first session, and the second request message includes the first request message.

Step 802: The communication management function sends the first request message to a first network function according to the fourth information, where the first network function is used for managing a first service.

The embodiment of the present application is applicable to a scenario in which the first request message is forwarded to the first network function through the communication management function, for example, a scenario shown in FIG. 3c.

It should be noted that the first request message, the second request message, the first session, the first service, and the first network function have the same meanings as the first request message, the second request message, the first session, the first service, and the first network function in the method embodiment shown in FIG. 2. In the embodiment of the present application, reference may be made to explanation and description in the method embodiment shown in FIG. 2 for the meanings of the first request message, the second request message, the first session, the first service, and the first network function. Details are not described herein again.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node includes a network function for processing the first service.

In an implementation, the fourth information is the first request message, that is, an AI session modification request message sent by the terminal, and is used for modifying the AI session between the terminal and the AI resource node.

Optionally, after the modification of the AI session is completed, based on a modification result of the AI session, the modification of the communication bearer or the communication policy related to the AI session is triggered.

For example, the communication management function may receive third information from the first network function.

The communication management function triggers, according to the third information, a process of modifying at least one of the communication bearer or the communication policy.

The third information includes at least one of the following:
session information of the modified first session; or
a first notification message, where the first notification message is used for indicating that a communication bearer or a communication policy related to the first session is modified.

In some implementations, the modification of the communication bearer is a process of modifying a PDU session.

In some implementations, the modification of the communication bearer is to modify communication QoS related information.

In some implementations, the modification of the communication policy is used for modifying a related policy used for communication or routing on a network or terminal side.

For example, a process of modifying the communication policy is an SM policy association modification process or a terminal policy modification process, or is used for modifying route information in a network, such as a forwarding action rule (FAR) or a packet detection rule (PDR).

Optionally, the session information includes at least one of the following:
service policy information, service resource configuration information, data source information, or model information.

Optionally, the first notification message includes third indication information. The third indication information indicates that the communication management function modifies QoS information of the communication bearer related to the first session.

The third information corresponds to the modified session information of the first session or the first notification message sent to the communication management function by the first network function after the AI session is modified in the method embodiment shown in FIG. 2. The third information enables the communication management function to trigger, according to the modified session information of the first session or the first notification message, a process of modifying at least one of the communication bearer or the communication policy related to the first session.

In another implementation, the fourth information is the first request message, and the first request message carries a modification content related to the communication bearer, for example, QoS information, in this case, the method may further include:
the communication management function triggers, according to the first request message, a process of modifying at least one of the communication bearer or the communication policy.

In the implementation, in a case that AI-related QoS and communication-related QoS are determined by application layer information of the terminal, if the QoS of the AI session needing modification influences the communication-related QoS, the communication management function may further trigger, based on the QoS information in the first request message, a process of modifying at least one of the communication bearer or the communication policy.

In still another implementation, the fourth information is a second request message. The second request message carries the first request message, or the fourth information includes the first request message and a second request message. In this case, the method may further include:
the communication management function triggers, according to at least one of the first request message or the second request message, a process of modifying at least one of the communication bearer or the communication policy.

For example, in a case that the fourth information includes the first request message and the second request message, step 3 and step 5 shown in FIG. 3c may be performed in parallel. That is, the AI session modification request message and the PDU session modification message are not in an inclusion relationship. For example, the AI session modification request message is outside the PDU session modification message. In this case, after receiving the AI session modification request message, the SMF triggers step 5. In this case, step 3 and step 5 are performed in parallel.

In a case that the fourth information is the second request message, and the second request message carries the first request message, as shown in FIG. 3c, step 5 is performed after step 3 is triggered. That is, the AI session modification request message is included in a dedicated IE container (for example, an AI container) in the PDU session modification message. The SMF detects the dedicated IE container when processing the PDU session modification message. In this case, the SMF does not process the dedicated IE container, but directly forwards the dedicated IE container to the AI service management function corresponding to the terminal.

In the implementation, the communication management function may trigger the process of modifying at least one of the communication bearer or the communication policy based on the second request message transmitted together with or in parallel with the first request message.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

In the embodiment of the present application, a meaning of the first layer is the same as that of the first layer in the method embodiment shown in FIG. 2. Reference may be made to explanation and description of the first layer in the method embodiment shown in FIG. 2 for a meaning related to the first layer. Details are not described herein again.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

In the embodiment of the present application, a meaning of the first request message is the same as that of the first request message in the method embodiment shown in FIG. 2. Reference may be made to explanation and description of the first request message in the method embodiment shown in FIG. 2 for a meaning related to the first request message. Details are not described herein again.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

In the embodiment of the present application, a meaning of the requirement description information of the first service is the same as that of the requirement description information of the first service in the method embodiment shown in FIG. 2. Reference may be made to explanation and description of the requirement description information of the first service in the method embodiment shown in FIG. 2 for a meaning related to the requirement description information of the first service. Details are not described herein again.

The embodiment of the present application may be combined with the method embodiments shown in FIG. 2 and FIG. 7, such that the communication management function can forward the first network function the first request message sent by the terminal. Then the first network function can modify the AI session according to the first request message of the terminal, and feed back a response message requesting modification of the AI session to the terminal. Details are not described herein again.

According to the method for modifying a session according to the embodiment of the present application, an execution subject may be an apparatus for modifying a session. In the embodiment of the present application, the apparatus for modifying a session provided in the embodiment of the present application is described with an example in which the apparatus for modifying a session performs the method for modifying a session.

With reference to FIG. 9, an apparatus 900 for modifying a session according to an embodiment of the present application may be an apparatus in a terminal. As shown in FIG. 9, the apparatus 900 for modifying a session may include the following modules:
a first sending module 901 configured to send a first request message to a first network function, where the first request message is used for requesting modification of a first session, the first session is used for bearing data of a first service, the first service includes at least one of an artificial intelligence AI service or a computing service, and the first network function is used for managing the first service; and
a first reception module 902 configured to receive a first response message from the first network function, where the first response message indicates a modification result of the first session.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node includes a network function for processing the first service.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

Optionally, the first sending module 901 is specifically configured to:
send the first request message to the first network function through a first network side device, where the first network side device has at least one of the following functions:
an NAS interface function;
a communication management function;
a policy charging function; or
a user plane function.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

Optionally, the first response message includes at least one of the following of the modified first session:
a session ID, QoS information, service policy information, service resource configuration information, data source information, or model information.

Optionally, the apparatus 900 for modifying a session further includes:
a service transmitting module configured to transmit data related to the first service based on the modified first session.

Optionally, in a case that the first layer is an upper layer of an NAS-SM layer or the first layer is an NAS-SM layer, the first request message is forwarded to the first network function through the NAS interface function and the communication management function.

Optionally, the first request message is carried in a second request message, and the second request message is used for requesting modification of a communication bearer related to the first session; or
the first request message is further used for requesting modification of a communication bearer related to the first session.

Optionally, in a case that the first layer is an upper layer of an NAS-MM layer and is parallel to an NAS-SM layer, or the first layer is an upper layer of a URSP layer, or the first layer is located between an NAS-MM layer and an NAS-SM layer, the first request message is forwarded to the first network function through the NAS interface function.

Optionally, the apparatus 900 for modifying a session further includes:
a determination module configured to determine, based on information of an application layer, at least one of QoS information of the first session or QoS information related to communication.

In a case that the QoS information of the first session influences the QoS information related to communication, the first request message further includes a second request message, the second request message is used for requesting modification of a communication bearer related to the first session, or the first request message is further used for requesting modification of a communication bearer related to the first session.

Optionally, the first layer is an upper layer of a PDU layer, and the first request message is transmitted to the first network function through the communication bearer related to the first session.

The apparatus 900 for modifying a session according to the embodiment of the present application can implement various processes of the method embodiment in FIG. 2, and achieve the same technical effect, which will not be repeated herein to avoid repetitions.

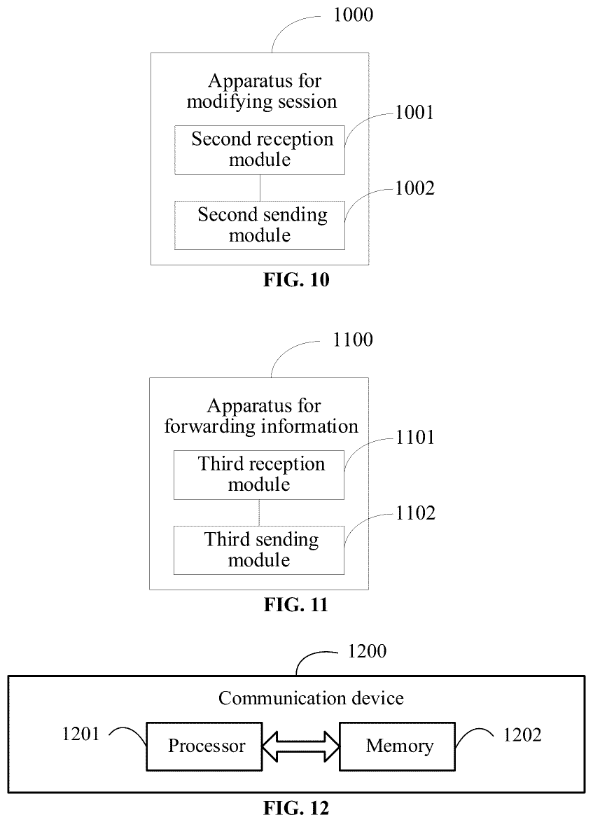

With reference to FIG. 10, an apparatus 1000 for modifying a session according to an embodiment of the present application may be an apparatus having a first network function. As shown in FIG. 10, the apparatus 1000 for modifying a session may include the following modules:
a second reception module 1001 configured to receive a first request message from a terminal, where the first request message is used for requesting modification of a first session, the first session is used for bearing data of a first service, the first service includes at least one of an artificial intelligence AI service or a computing service, the apparatus 1000 for modifying a session has a first network function, and the first network function is used for managing the first service; and
a second sending module 1002 configured to send a first response message to the terminal, where the first response message indicates a modification result of the first session.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node is a network function for processing the first service.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

Optionally, the first request message is forwarded to the first network function through a first network side device. The first network side device has at least one of the following functions:
an NAS interface function;
a communication management function;
a policy charging function; or
a user plane function.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

Optionally, the first response message includes at least one of the following of the modified first session:
a session ID, QoS information, service policy information, service resource configuration information, data source information, or model information.

Optionally, the apparatus 1000 for modifying a session further includes:
a first modification module configured to modify a service policy according to the modified first session.

Optionally, the service policy includes at least one of the following:
data transmission resource information related to the data of the first service, a data forwarding rule related to the data of the first service, a data caching rule related to the data of the first service, network context information related to the data of the first service, a data matching policy of a terminal side for the first session, or a data sending policy of a terminal side for the first session.

Optionally, the apparatus 1000 for modifying a session further includes:
a fourth sending module configured to send third information to the communication management function. The third information includes at least one of the following:
session information of the modified first session; or
a first notification message, where the first notification message is used for indicating that a communication bearer or a communication policy related to the first session is modified.

Optionally, the session information includes at least one of the following:
service policy information, service resource configuration information, data source information, or model information.

Optionally, the first notification message includes third indication information. The third indication information indicates that the communication management function modifies QoS information of the communication bearer related to the first session.

Optionally, the second reception module 1001 is specifically configured to:
receive the first request message of the terminal that is forwarded by the communication management function. The first layer satisfies any one of the following:
the first layer is an upper layer of a non-access stratum session management NAS-SM layer; or
the first layer is an NAS-SM layer.

Optionally, the second reception module 1001 is specifically configured to:
receive the first request message of the terminal that is forwarded by the NAS interface function, where the first layer encapsulating the first request message is an upper layer of a non-access stratum mobility management NAS-MM layer and is parallel to an NAS-SM layer, or the first layer is located between an NAS-MM layer and an NAS-SM layer;
or
receive the first request message of the terminal that is forwarded by the NAS interface function and the policy charging function, where the first layer is an upper layer of a URSP layer.

Optionally, the first request message includes a second request message, and the second request message is used for requesting modification of the communication bearer related to the first session; or
the first request message is further used for requesting modification of the communication bearer related to the first session.

Optionally, the first layer is an upper layer of a PDU layer, and the first request message is transmitted to the first network function through the communication bearer related to the first session.

Optionally, the apparatus 1000 for modifying a session further includes:
a second modification module configured to modify at least one of the following of the first session according to the first request message:
a transmission mode of the data of the first service;
a service resource of the first service;
a data source of the first service;
a model of the first service; or
a bearer of the first session.

Optionally, the second modification module is specifically configured to:
modify a model used by the terminal in the first session in a case of determining that the first request message satisfies a first condition.

The first condition includes at least one of the following:
the first request message includes the requirement description information of the first service, and the requirement description information of the first service includes model information;
the requirement description information of the first service includes the QoS information of the first service, and the QoS information of the first service does not match model information used by the terminal;
the second information in the first request message includes the QoS information related to the first session, and the QoS information related to the first session does not match model information used by the terminal; or
the first request message includes the second indication information, the second indication information indicates a need to interact with a second network function, and the second network function is used for model management.

Optionally, the second modification module is specifically configured to:
modify a data source of the terminal in the first session in a case of determining that the first request message satisfies a second condition.

The second condition includes at least one of the following:
the first request message carries the data source information;
the first request message includes the second indication information, the second indication information indicates a need to interact with a fourth network function, and the fourth network function is used for performing data management;
the requirement description information of the first service includes the model information, and the model information does not match data source information used by the terminal in the first session;
the requirement description information of the first service includes the QoS information of the first service, and the QoS information of the first service does not match data source information used by the terminal in the first session; or
the second information in the first request message includes the QoS information related to the first session, and the QoS information related to the first session does not match data source information used by the terminal in the first session.

Optionally, the second modification module is specifically configured to:
modify a service resource used by the terminal in the first session in a case of determining that the first request message satisfies a third condition.

The third condition includes at least one of the following:
the requirement description information of the first service includes the model information, and the model information does not match service resource information used by the terminal in the first session;
the requirement description information of the first service includes the QoS information of the first service, and the QoS information of the first service does not match service resource information used by the terminal in the first session;
the second information in the first request message includes the QoS information related to the first session, and the QoS information related to the first session does not match service resource information used by the terminal in the first session; or
the first request message includes the second indication information, the second indication information indicates a need to interact with a third network function, and the third network function is used for service resource management.

Optionally, the apparatus 1000 for modifying a session further includes:
a fifth sending module configured to send a fifth request message to the second network function according to the first request message, where the fifth request message is used for requesting modification of the model of the first service, and the second network function is used for model management; and
a fourth reception module configured to receive a fifth response message from the second network function, where the fifth response message indicates a modification result of the model of the first service.

Optionally, the fifth request message includes at least one of the following:
an identity of the terminal;
a data network name DNN to which the first session belongs;
single network slice selection assistance information S-NSSAI of the first session;
information of a service area to which the first session belongs; or
the requirement description information of the first service.

Optionally, the apparatus 1000 for modifying a session further includes:
a sixth sending module configured to send a sixth request message to the fourth network function according to the first request message, where the sixth request message is used for requesting modification of the data source of the first service, and the fourth network function is used for performing data management; and
a fifth reception module configured to receive a sixth response message from the fourth network function, where the sixth response message indicates a modification result of the data source of the first service.

Optionally, the sixth request message includes at least one of the following:
the identity of the terminal;
the data network name DNN to which the first session belongs;
the single network slice selection assistance information S-NSSAI of the first session;
the information of the service area to which the first session belongs; or
the requirement description information of the first service.

Optionally, the apparatus 1000 for modifying a session further includes:
a seventh sending module configured to send a seventh request message to the third network function according to the first request message, where the seventh request message is used for requesting modification of a resource of the first service, and the third network function is used for service resource management; and
a sixth reception module configured to receive a seventh response message from the third network function, where the seventh response message indicates a modification result of the resource of the first service.

Optionally, the seventh request message includes at least one of the following:
the identity of the terminal;
the data network name DNN to which the first session belongs;
the single network slice selection assistance information S-NSSAI of the first session;
the information of the service area to which the first session belongs;
the requirement description information of the first service;
data source information of the first service;
a computational load of the first service; or
application server AS address information of the first service.

Optionally, the apparatus 1000 for modifying a session further includes:
an eighth sending module configured to send an eighth request message to the first resource node according to the first request message, where the eighth request message is used for requesting to modification of the bearer of the first session, the eighth request message includes the service resource configuration information, and the first resource node includes the network function for processing the first service; and
a seventh reception module configured to receive an eighth response message from the first resource node, where the eighth response message indicates a modification result of the bearer of the first session.

Optionally, the service resource configuration information includes at least one of the following:
the data source information of the first service;
service resource information of the first service;
detection information of the first service;
a processing rule of the first service; or
the AS address information of the first service.

The apparatus 1000 for modifying a session according to the embodiment of the present application can implement various processes of the method embodiment in FIG. 7, and achieve the same technical effect, which will not be repeated herein to avoid repetitions.

With reference to FIG. 11, an apparatus 1100 for forwarding information according to an embodiment of the present application may be an apparatus having a communication management function. As shown in FIG. 11, the apparatus 1100 for forwarding information may include the following modules:
a third reception module 1101 configured to receive fourth information from a terminal; and
a third sending module 1102 configured to send a first request message to a first network function according to the fourth information, where the first network function is used for managing a first service.

The fourth information includes at least one of the following:
the first request message, where the first request message is used for requesting modification of a first session, the first session is used for bearing service data of the first service, and the first service includes at least one of an artificial intelligence AI service or a computing service; or
a second request message, where the second request message is used for requesting modification of a communication bearer related to the first session, and the second request message includes the first request message.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node includes a network function for processing the first service.

Optionally, the apparatus 1100 for forwarding information further includes:
a third modification module configured to trigger, according to the first request message or the second request message, a process of modifying at least one of the communication bearer or a communication policy.

Optionally, the apparatus 1100 for forwarding information further includes:
an eighth reception module configured to receive third information from the first network function; and
a fourth modification module configured to trigger, according to the third information, a process of modifying at least one of the communication bearer or a communication policy.

The third information includes at least one of the following:
session information of the modified first session; or
a first notification message, where the first notification message is used for indicating that a communication bearer or a communication policy related to the first session is modified.

Optionally, the session information includes at least one of the following:
service policy information, service resource configuration information, data source information, or model information.

Optionally, the first notification message includes third indication information. The third indication information indicates that the communication management function modifies QoS information of the communication bearer related to the first session.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

The apparatus 1100 for forwarding information according to the embodiment of the present application may implement various processes implemented by the method embodiment of FIG. 8, and achieve the same technical effect, which will not be repeated herein to avoid repetitions.

The apparatus for modifying a session and the apparatus for forwarding information in the embodiments of the present application may be electronic devices, for example, electronic devices having an operating system, or components in an electronic device, such as integrated circuits or chips. The electronic device may be a terminal or a network side device. Illustratively, the terminal may include, but is not limited to, the types of the terminal 11 listed above. The network side device includes, but is not limited to, the types of the core network device listed above. This is not specifically limited in the embodiment of the present application.

Optionally, as shown in FIG. 12, a communication device 1200 is further provided in the embodiments of the present application. The communication device includes a processor 1201 and a memory 1202. The memory 1202 stores a program or instructions runnable on the processor 1201. For example, in a case that the communication device 1200 is a terminal, the program or instructions, when executed by the processor 1201, implement each step in the method embodiment for modifying a session shown in FIG. 2, and achieve the same technical effects. In a case that the communication device 1200 is a network side device, the program or instructions, when executed by the processor 1201, implement each step in the embodiment of the method for modifying a session shown in FIG. 7 or the embodiment of the method for forwarding information shown in FIG. 8, and achieves the same technical effects, which will not be repeated herein to avoid repetitions.

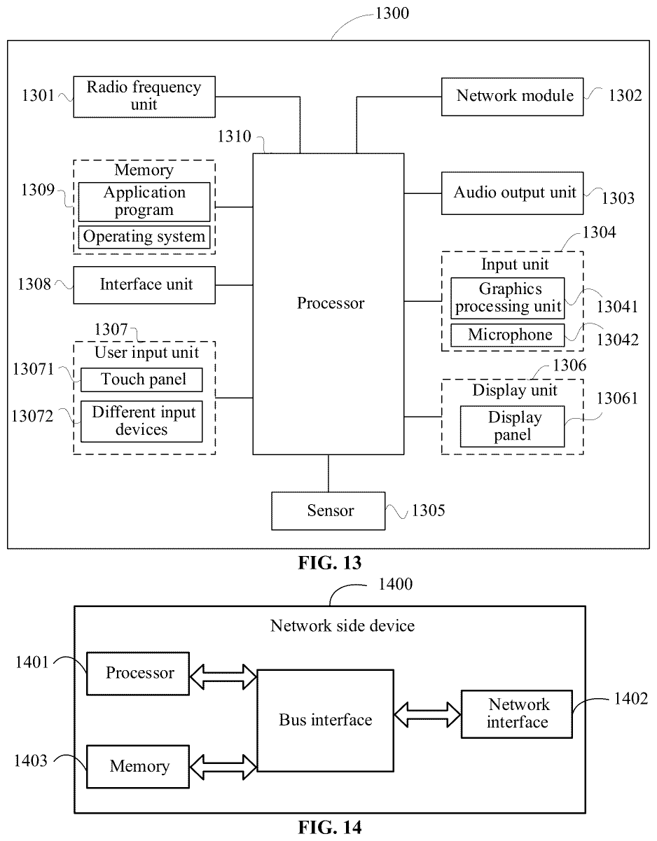

An embodiment of the present application further provides a terminal, including a processor and a communication interface. The communication interface is coupled to the processor. The processor is configured to run a program or instructions, to implement the steps of the method embodiment shown in FIG. 2. The terminal embodiment corresponds to the foregoing terminal side method embodiment, and each implementation process and implementation of the foregoing method embodiment can be applied to the terminal embodiment, and can achieve the same technical effects. Specifically, FIG. 13 is a schematic structural diagram of hardware of a terminal according to an embodiment of the present application.

The terminal 1300 includes, but is not limited to, at least some components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

Those skilled in the art may appreciate that the terminal 1300 may further include a power supply (such as a battery) for supplying power to the components. The power supply may be logically connected to the processor 1310 by a power management system, thereby implementing functions such as charging, discharging, and power consumption management by using the power management system. A terminal structure shown in FIG. 9 does not constitute a limitation to the terminal. The terminal may include more or fewer components than those shown in the figure, or some components may be combined, or a different component deployment may be used, and details are not repeated herein.

It should be understood that in the embodiment of the present application, the input unit 1304 may include a graphics processing unit (GPU) 13041 and a microphone 13042. The graphics processing unit 13041 performs processing on image data of a static picture or a video that is obtained by an image capture device (for example, a camera) in a video capture mode or an image capture mode. The display unit 1306 may include a display panel 13061. The display panel 13061 may be configured in a form of a liquid crystal display, an organic light-emitting, and the like. The user input unit 1307 includes at least one of a touch panel 13071 or another input device 13072. The touch panel 13071 is also referred to as a touchscreen. The touch panel 13071 may include two parts of a touch detection apparatus and a touch controller. The another input device 13072 may include, but is not limited to, a physical keyboard, a functional key (such as a volume control key or a switch key), a track ball, a mouse, and a joystick, and details are omitted herein.

In the embodiment of the present application, after receiving downlink data from a network side device, the radio frequency unit 1301 may transmit the downlink data to the processor 1310 for processing. Moreover, the radio frequency unit 1301 may send uplink data to the network side device. Generally, the radio frequency unit 1301 includes, but is not limited to, an antenna, an amplifier, a transceiver, a coupler, a low noise amplifier, a duplexer, and the like.

The memory 1309 may be configured to store a software program or instruction and various data. The memory 1309 may mainly include a first storage area for storing a program or instructions, and a second storage area for storing data. The first storage area may store an operating system, an application program or an instruction required by at least one function (for example, a sound playback function, and an image display function), and the like. Furthermore, the memory 1309 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct Rambus random access memory (DRRAM). The memory 1309 in the embodiment of the present application includes, but is not limited to, these memories and any other suitable types of memories.

The processor 1310 may include one or more processing units. Optionally, the processor 1310 integrates an application processor and a modem processor. The application processor mainly processes operations related to an operating system, a user interface, an application, and the like. The modem processor mainly processes wireless communication signals, and is, for example, a baseband processor. It can be understood that the modem processor may not be integrated into the processor 1310.

The radio frequency unit 1301 is configured to send a first request message to a first network function. The first request message is used for requesting modification of a first session. The first session is used for bearing data of a first service. The first service includes at least one of an artificial intelligence AI service or a computing service. The first network function is used for managing the first service.

The radio frequency unit 1301 is further configured to receive a first response message from the first network function. The first response message indicates a modification result of the first session.

Optionally, the first session satisfies at least one of the following:
the first session is a bearer between the terminal and a first resource node;
the first session has a first identity uniquely identifying the first session;
the first session has at least one of a dedicated data network name DNN or single network slice selection assistance information S-NSSAI; or
the first session has a quality of service QoS guarantee between the terminal and a first resource node.

The first resource node includes a network function for processing the first service.

Optionally, the first request message is encapsulated in a first layer. The first layer satisfies any one of the following:
the first layer is an upper layer of a non-access stratum session management NAS-SM layer;
the first layer is an upper layer of a non-access stratum mobility management NAS-MM layer, and is parallel to an NAS-SM layer;
the first layer is located between an NAS-MM layer and an NAS-SM layer;
the first layer is an upper layer of a UE route selection policy URSP layer;
the first layer is an NAS-SM layer; or
the first layer is an upper layer of a protocol data unit PDU layer.

Optionally, the radio frequency unit 1301 sends the first request message to the first network function as follows:
the first request message is sent to the first network function through a first network side device. The first network side device has at least one of the following functions:
an NAS interface function;
a communication management function;
a policy charging function; or
a user plane function.

Optionally, the first request message includes at least one of the following:
requirement description information of the first service;
a session type indication, where the session type indication indicates a type of a session that requests modification;
first information, where the first information includes information of a communication resource related to the first session;
second information, where the second information includes information of the first session;
first indication information, where the first indication information is used for indicating that the first service needs participation of an application server AS; or
AS address information.

Optionally, the requirement description information of the first service includes at least one of the following:
an identity of the first service;
a quality of experience QoE requirement of the first service;
quality of service QoS information of the first service;
model information of the first service; or
second indication information, where the second indication information indicates whether interaction with a target network function needs to be performed.

Optionally, the first response message includes at least one of the following of the modified first session:
a session ID, QoS information, service policy information, service resource configuration information, data source information, or model information.

Optionally, the radio frequency unit 1301 is further configured to transmit data related to the first service based on the modified first session.

Optionally, in a case that the first layer is an upper layer of an NAS-SM layer or the first layer is an NAS-SM layer, the first request message is forwarded to the first network function through the NAS interface function and the communication management function.

Optionally, the first request message is carried in a second request message, and the second request message is used for requesting modification of a communication bearer related to the first session; or
the first request message is further used for requesting modification of a communication bearer related to the first session.

Optionally, in a case that the first layer is an upper layer of an NAS-MM layer and is parallel to an NAS-SM layer, or the first layer is an upper layer of a URSP layer, or the first layer is located between an NAS-MM layer and an NAS-SM layer, the first request message is forwarded to the first network function through the NAS interface function.

Optionally, the processor 1310 is configured to determine, based on information of an application layer, at least one of QoS information of the first session or QoS information related to communication.

In a case that the QoS information of the first session influences the QoS information related to communication, the first request message further includes a second request message, the second request message is used for requesting modification of a communication bearer related to the first session, or the first request message is further used for requesting modification of a communication bearer related to the first session.

Optionally, the first layer is an upper layer of a PDU layer, and the first request message is transmitted to the first network function through the communication bearer related to the first session.

It can be understood that reference may be made to relevant description of the embodiment of the method for modifying a session shown in FIG. 2 for an implementation process of each implementation mentioned in the embodiment. The same or corresponding technical effects can be achieved, and will not be repeated herein to avoid repetitions.

An embodiment of the present application further provides a network side device. The network side device includes a processor and a communication interface. The communication interface is coupled to the processor. The processor is configured to run a program or instructions, to implement steps in the method embodiment shown in FIG. 7 or FIG. 8. The network side device embodiment corresponds to the foregoing network side device method embodiment. Each implementation process and implementation of the foregoing method embodiment can be applied to the network side device embodiment, and can achieve the same technical effects.

Specifically, an embodiment of the present application further provides a network side device. As shown in FIG. 14, the network side device 1400 includes a processor 1401, a network interface 1402, and a memory 1403. The network interface 1402 is, for example, a common public radio interface (CPRI).

Specifically, the network side device 1400 in the embodiment of the present application further includes: instructions or a program stored in the memory 1403 and runnable on the processor 1401. The processor 1401 invokes the instructions or the program in the memory 1403 to perform the method performed by various modules shown in FIG. 10 or FIG. 11, and can achieve the same technical effects, which will not be repeated herein to avoid repetitions.

An embodiment of the present application further provides a readable storage medium. The readable storage medium stores a program or instructions. The program or instructions, when executed by a processor, implement various processes in the method embodiment shown in FIG. 2, FIG. 7, or FIG. 8, and can achieve the same technical effects, which will not be repeated herein to avoid repetitions.

The processor is the processor in the terminal described in the above embodiment. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of the present application further provides a chip. The chip includes a processor and a communication interface. The communication interface is coupled to the processor. The processor is configured to run a program or instructions, to implement various processes in the method embodiment shown in FIG. 2, FIG. 7, or FIG. 8, and can achieve the same technical effects, which will not be repeated herein to avoid repetitions.

It should be understood that the chip mentioned in the embodiment of the present application may alternatively be referred to as a system-level chip, a system chip, a chip system, a system-on-chip, or the like.

An embodiment of the present application further provides a computer program/program product. The computer program/program product is stored in a storage medium. The computer program/program product is executed by at least one processor to implement various processes in the method embodiment shown in FIG. 2, FIG. 7, or FIG. 8, and can achieve the same technical effects, which will not be repeated herein to avoid repetitions.

An embodiment of the present application further provides a wireless communication system. The wireless communication system includes a terminal, a network side device having a first network function, and a network side device having a communication management function. The terminal may be configured to perform steps of the method embodiment shown in FIG. 2. The network side device having a first network function may be configured to perform steps of the method embodiment shown in FIG. 7. The network side device having a communication management function may be configured to perform steps of the method embodiment shown in FIG. 8.

In a first implementation, as shown in FIG. 3a, assuming that the network side device having a first network function is an AI service management function, the network side device having a communication management function is the communication management function, and an AI layer is an upper layer of an NAS-SM layer,
in this case, an interaction process between the terminal, the AI service management function, and the communication management function includes: the terminal encapsulates a first request message onto the AI layer, and sends an MM message to an NAS interface function. The NAS interface function decodes the MM message, and sends, when detecting an encapsulated NAS-SM layer message, the NAS-SM layer message to the communication management function. The communication management function decodes the NAS-SM layer message, and sends, when detecting an encapsulated AI layer message, the AI layer message to the AI service management function. The AI service management function decodes the AI layer message, to obtain the first request message.

In a second implementation, as shown in FIG. 3b, assuming that the network side device having a first network function is an AI service management function, the network side device having a communication management function is the communication management function, and an AI layer is an NAS-SM layer, that is, the NAS-SM layer is enhanced,
in this case, an interaction process between the terminal, the AI service management function, and the communication management function includes: the terminal encapsulates a first request message onto the AI layer, and sends an MM message to an NAS interface function. The NAS interface function decodes the MM message, and sends, when detecting an encapsulated NAS-SM layer message, the NAS-SM layer message to the communication management function. The communication management function decodes the NAS-SM layer message, and sends, when detecting an AI layer message, the AI layer message to the AI service management function. The AI service management function decodes the AI layer message, to obtain the first request message.

In a third implementation, as shown in FIG. 4a, assuming that the network side device having a first network function is an AI service management function, the network side device having a communication management function is the communication management function, and the AI layer is an upper layer of an NAS-MM layer and is parallel to an NAS-SM layer,
in this case, an interaction process between the terminal, the AI service management function, and the communication management function includes: the terminal encapsulates a first request message onto the AI layer, and sends an MM message to an NAS interface function. The NAS interface function decodes the MM message, sends, when detecting an encapsulated NAS-SM layer message, the NAS-SM layer message to the communication management function, and sends, when detecting an encapsulated AI layer message, the AI layer message to the AI service management function. The AI service management function decodes the AI layer message, to obtain the first request message.

In a fourth implementation, as shown in FIG. 4b, assuming that the network side device having a first network function is an AI service management function, the network side device having a communication management function is the communication management function, and the AI layer is an upper layer of an NAS-MM layer and is parallel to an NAS-SM layer,
in this case, an interaction process between the terminal, the AI service management function, and the communication management function includes: the terminal encapsulates a first request message onto the AI layer, and sends an MM message to an NAS interface function. The NAS interface function decodes the MM message, sends, when detecting an encapsulated NAS-SM layer message, the NAS-SM layer message to the communication management function, and sends, when detecting an encapsulated AI layer message, the AI layer message to the AI service management function. The AI service management function decodes the AI layer message, to obtain the first request message.

In a fifth implementation, as shown in FIG. 5a, assuming that the network side device having a first network function is an AI service management function, the network side device having a communication management function is the communication management function, and the AI layer is located between an NAS-MM layer and an NAS-SM layer,
in this case, an interaction process between the terminal, the AI service management function, and the communication management function includes: the terminal encapsulates a first request message onto the AI layer, and sends an MM message to an NAS interface function. The NAS interface function decodes the MM message, and sends, when detecting an encapsulated AI layer message, the AI layer message to the AI service management function. The AI service management function decodes the AI layer message to obtain the first request message, and sends, when detecting an encapsulated NAS-SM layer message, the NAS-SM layer message to the communication management function.

In a sixth implementation, as shown in FIG. 6a, assuming that the network side device having a first network function is an AI service management function, and the AI layer is located at an upper layer of a PDU layer,
in this case, an interaction process between the terminal and the AI service management function includes: the terminal first establishes a PDU session, then uses a user plane of the PDU session to send control signaling to the AI service management function to modify the AI session, and then may use the PDU session to transmit AI-related data. The AI signaling and data may be sent by using different QoS flows in the PDU session. That is, a QoS flow of the AI signaling is a UE-AI service management function, and a QoS flow of the AI data is a UE-UPF-AI resource node.

It should be noted that in this specification, the term “include”, “comprise”, or their any other variants are intended to encompass in a non-exclusive mode, such that a process, a method, an object, or an apparatus including a series of elements not only includes those elements, but also includes other elements that are not explicitly listed, or elements that are inherent to such a process, a method, an object, or an apparatus. Without more limitations, an element defined by a sentence “comprise a . . . ” or “include a . . . ” does not exclude existence of other same elements in the process, the method, the object, or the apparatus that includes the element. Moreover, it should be noted that a scope of the method and the apparatus in the implementations of this application is not limited to performing functions in a sequence that is shown or discussed, but may further include performing functions in a substantially simultaneous manner or in a reversed sequence according to the functions involved. For example, the described method may be performed in a different order than a described order, and various steps may be added, omitted, or combined. Furthermore, features described with reference to some examples may be combined in other examples.

Through the description of the foregoing implementations, those skilled in the art can clearly understand that the methods according to the foregoing embodiments may be implemented by a computer software product and a necessary general hardware platform, and certainly, may alternatively be implemented by hardware. The computer software product is stored in a storage medium (such as an ROM/RAM, a magnetic disk, or an optical disc) and includes several instructions for instructing a terminal or a network side device to perform the methods described in the embodiments of the present application.

The embodiments of the present application are described above with reference to the accompanying drawings. However, the present application is not limited to the specific implementations described above, and the specific implementations described above are merely illustrative and not limitative.

What is claimed is:

1. A method for modifying a session, comprising:
sending, by a terminal, a first request message to a first network function, wherein the first request message is used for requesting modification of a first session, the first session is used for bearing data of a first service, the first service comprises at least one of an artificial intelligence (AI) service or a computing service, and the first network function is used for managing the first service; and
receiving, by the terminal, a first response message from the first network function, wherein the first response message indicates a modification result of the first session.

2. The method according to claim 1, wherein the first session satisfies at least one of the following:
the first session is a bearer between the terminal and a first resource node;
the first session has a first identity uniquely identifying the first session;
the first session has at least one of a dedicated data network name (DNN) or single network slice selection assistance information (S-NSSAI); or
the first session has a quality of service (QoS) guarantee between the terminal and a first resource node, wherein
the first resource node comprises a network function for processing the first service.

3. The method according to claim 1, wherein the first request message is encapsulated in a first layer, and the first layer satisfies any one of the following:
the first layer is an upper layer of a non-access stratum session management (NAS-SM) layer;
the first layer is an upper layer of a non-access stratum mobility management (NAS-MM) layer, and is parallel to an NAS-SM layer;
the first layer is located between an NAS-MM layer and an NAS-SM layer;
the first layer is an upper layer of a UE route selection policy (URSP) layer;
the first layer is an NAS-SM layer; or
the first layer is an upper layer of a protocol data unit (PDU) layer.

4. The method according to claim 1, wherein the sending, by a terminal, a first request message to a first network function comprises:
sending, by the terminal, the first request message to the first network function through a first network side device, wherein the first network side device has at least one of the following functions:
an NAS interface function;
a communication management function;
a policy charging function; or
a user plane function.

5. The method according to claim 1, wherein the first request message comprises at least one of the following:
requirement description information of the first service;
a session type indication, wherein the session type indication indicates a type of a session that requests modification;
first information, wherein the first information comprises information of a communication resource related to the first session;
second information, wherein the second information comprises information of the first session;
first indication information, wherein the first indication information is used for indicating that the first service needs participation of an application server (AS); or
AS address information;
wherein the requirement description information of the first service comprises at least one of the following:
an identity of the first service;
a quality of experience (QoE) requirement of the first service;
quality of service (QoS) information of the first service;
model information of the first service; or
second indication information, wherein the second indication information indicates whether interaction with a target network function needs to be performed.

6. The method according to claim 3, wherein in a case that the first layer is an upper layer of an NAS-SM layer or the first layer is an NAS-SM layer, the first request message is forwarded to the first network function through the NAS interface function and the communication management function;
wherein
the first request message is carried in a second request message, and the second request message is used for requesting modification of a communication bearer related to the first session; or
the first request message is further used for requesting modification of a communication bearer related to the first session.

7. The method according to claim 3, wherein in a case that the first layer is an upper layer of an NAS-MM layer and is parallel to an NAS-SM layer, or the first layer is an upper layer of a URSP layer, or the first layer is located between an NAS-MM layer and an NAS-SM layer, the first request message is forwarded to the first network function through the NAS interface function;
the method further comprises:
determining, by the terminal based on information of an application layer, at least one of QoS information of the first session or QoS information related to communication, wherein
in a case that the QoS information of the first session influences the QoS information related to communication, the first request message further comprises a second request message, the second request message is used for requesting modification of a communication bearer related to the first session, or the first request message is further used for requesting modification of a communication bearer related to the first session.

8. A method for modifying a session, comprising:
receiving, by a first network function, a first request message from a terminal, wherein the first request message is used for requesting modification of a first session, the first session is used for bearing data of a first service, the first service comprises at least one of an artificial intelligence (AI) service or a computing service, and the first network function is used for managing the first service; and
sending, by the first network function, a first response message to the terminal, wherein the first response message indicates a modification result of the first session.

9. The method according to claim 8, wherein the first session satisfies at least one of the following:
the first session is a bearer between the terminal and a first resource node;
the first session has a first identity uniquely identifying the first session;
the first session has at least one of a dedicated data network name (DNN) or single network slice selection assistance information (S-NSSAI); or
the first session has a quality of service (QoS) guarantee between the terminal and a first resource node, wherein
the first resource node is a network function for processing the first service.

10. The method according to claim 8, wherein the first request message is encapsulated in a first layer, and the first layer satisfies any one of the following:
the first layer is an upper layer of a non-access stratum session management (NAS-SM) layer;
the first layer is an upper layer of a non-access stratum mobility management (NAS-MM) layer, and is parallel to an NAS-SM layer;
the first layer is located between an NAS-MM layer and an NAS-SM layer;
the first layer is an upper layer of a UE route selection policy (URSP) layer;
the first layer is an NAS-SM layer; or
the first layer is an upper layer of a protocol data unit (PDU) layer.

11. The method according to claim 8, wherein the first request message is forwarded to the first network function through a first network side device, and the first network side device has at least one of the following functions:
an NAS interface function;
a communication management function;
a policy charging function; or
a user plane function.

12. The method according to claim 8, wherein the first request message comprises at least one of the following:
requirement description information of the first service;
a session type indication, wherein the session type indication indicates a type of a session that requests modification;
first information, wherein the first information comprises information of a communication resource related to the first session;
second information, wherein the second information comprises information of the first session;
first indication information, wherein the first indication information is used for indicating that the first service needs participation of an application server (AS); or
AS address information;
wherein the requirement description information of the first service comprises at least one of the following:
an identity of the first service;
a quality of experience (QoE) requirement of the first service;
quality of service (QoS) information of the first service;
model information of the first service; or
second indication information, wherein the second indication information indicates whether interaction with a target network function needs to be performed.

13. The method according to claim 8, further comprising:
sending, by the first network function, third information to the communication management function, wherein the third information comprises at least one of the following:
session information of the modified first session; or
a first notification message, wherein the first notification message is used for indicating that a communication bearer or a communication policy related to the first session is modified;
wherein the session information comprises at least one of the following:
service policy information, service resource configuration information, data source information, or model information;
wherein the first notification message comprises third indication information, wherein the third indication information indicates that the communication management function modifies QoS information of the communication bearer related to the first session.

14. The method according to claim 10, wherein the receiving, by a first network function, a first request message from a terminal comprises:
receiving, by the first network function, the first request message of the terminal that is forwarded by the communication management function, wherein the first layer satisfies any one of the following:
the first layer is an upper layer of a non-access stratum session management (NAS-SM) layer; or
the first layer is an NAS-SM layer;
or,
wherein the receiving, by a first network function, a first request message from a terminal comprises:
receiving, by the first network function, the first request message of the terminal that is forwarded by the NAS interface function, wherein the first layer encapsulating the first request message is an upper layer of a non-access stratum mobility management (NAS-MM) layer and is parallel to an NAS-SM layer, or the first layer is located between an NAS-MM layer and an NAS-SM layer;
or
receiving, by the first network function, the first request message of the terminal that is forwarded by the NAS interface function and the policy charging function, wherein the first layer is an upper layer of a URSP layer;
wherein
the first request message comprises a second request message, and the second request message is used for requesting modification of the communication bearer related to the first session; or
the first request message is further used for requesting modification of the communication bearer related to the first session.

15. The method according to claim 8, further comprising:
modifying, by the first network function, at least one of the following of the first session according to the first request message:
a transmission mode of the data of the first service;
a service resource of the first service;
a data source of the first service;
a model of the first service; or
a bearer of the first session.

16. The method according to claim 15, wherein the modifying, by the first network function, the first session according to the first request message comprises:
modifying, by the first network function, a model used by the terminal in the first session in a case of determining that the first request message satisfies a first condition, wherein
the first condition comprises at least one of the following:
the first request message comprises the requirement description information of the first service, and the requirement description information of the first service comprises model information;
the requirement description information of the first service comprises the QoS information of the first service, and the QoS information of the first service does not match model information used by the terminal;
the second information in the first request message comprises the QoS information related to the first session, and the QoS information related to the first session does not match model information used by the terminal; or
the first request message comprises the second indication information, the second indication information indicates a need to interact with a second network function, and the second network function is used for model management;
or,
wherein the modifying, by the first network function, the first session according to the first request message comprises:
modifying, by the first network function, a data source of the terminal in the first session in a case of determining that the first request message satisfies a second condition, wherein
the second condition comprises at least one of the following:
the first request message carries the data source information;
the first request message comprises the second indication information, the second indication information indicates a need to interact with a fourth network function, and the fourth network function is used for performing data management;
the requirement description information of the first service comprises the model information, and the model information does not match data source information used by the terminal in the first session;
the requirement description information of the first service comprises the QoS information of the first service, and the QoS information of the first service does not match data source information used by the terminal in the first session; or
the second information in the first request message comprises the QoS information related to the first session, and the QoS information related to the first session does not match data source information used by the terminal in the first session;
or,
wherein the modifying, by the first network function, the first session according to the first request message comprises:
modifying, by the first network function, a service resource used by the terminal in the first session in a case of determining that the first request message satisfies a third condition, wherein
the third condition comprises at least one of the following:
the requirement description information of the first service comprises the model information, and the model information does not match service resource information used by the terminal in the first session;
the requirement description information of the first service comprises the QoS information of the first service, and the QoS information of the first service does not match service resource information used by the terminal in the first session;
the second information in the first request message comprises the QoS information related to the first session, and the QoS information related to the first session does not match service resource information used by the terminal in the first session; or
the first request message comprises the second indication information, the second indication information indicates a need to interact with a third network function, and the third network function is used for service resource management.

17. A method for forwarding information, comprising:
receiving, by a communication management function, fourth information from a terminal; and
sending, by the communication management function, a first request message to a first network function according to the fourth information, wherein the first network function is used for managing a first service, and
the fourth information comprises at least one of the following:
the first request message, wherein the first request message is used for requesting modification of a first session, the first session is used for bearing service data of the first service, and the first service comprises at least one of an artificial intelligence (AI) service or a computing service; or
a second request message, wherein the second request message is used for requesting modification of a communication bearer related to the first session, and the second request message comprises the first request message.

18. The method according to claim 17, wherein the first session satisfies at least one of the following:
the first session is a bearer between the terminal and a first resource node;
the first session has a first identity uniquely identifying the first session;
the first session has at least one of a dedicated data network name (DNN) or single network slice selection assistance information (S-NSSAI); or
the first session has a quality of service (QoS) guarantee between the terminal and a first resource node, wherein
the first resource node comprises a network function for processing the first service.

19. The method according to claim 17, further comprising:
triggering, by the communication management function according to the first request message or the second request message, a process of modifying at least one of the communication bearer or a communication policy.

20. The method according to claim 17, further comprising:
receiving, by the communication management function, third information from the first network function; and
triggering, by the communication management function according to the third information, a process of modifying at least one of the communication bearer or a communication policy, wherein
the third information comprises at least one of the following:
session information of the modified first session; or
a first notification message, wherein the first notification message is used for indicating that a communication bearer or a communication policy related to the first session is modified;
wherein the session information comprises at least one of the following:
service policy information, service resource configuration information, data source information, or model information;
wherein the first notification message comprises third indication information, wherein the third indication information indicates that the communication management function modifies QoS information of the communication bearer related to the first session.
